(19) United States
(12) Patent Application Publication
(10) Pub. No.: US 2022/0223873 A1
(43) Pub. Date: Jul. 14, 2022

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Yuta HIRANO, Kyoto (JP)

(21) Appl. No.: 17/708,623

(22) Filed: Mar. 30, 2022

Related U.S. Application Data
(63) Continuation of application No. PCT/JP2020/033531, filed on Sep. 4, 2020.

(30) Foreign Application Priority Data
Sep. 30, 2019 (JP) 2019-178789

(51) Int. Cl. H01M 4/62; H01M 10/0525; H01M 50/489; H01M 4/525; H01M 4/587

(52) U.S. Cl. CPC H01M 4/62; H01M 10/0525; H01M 2004/021; H01M 4/525; H01M 4/587; H01M 50/489

(57) ABSTRACT

A secondary battery includes a positive electrode, a negative electrode, and an intermediate layer. The positive electrode and the negative electrode are opposed to each other with a separator interposed therebetween. The intermediate layer is disposed between the negative electrode and the separator, and includes inorganic particles and a binder. The intermediate layer includes a first intermediate part that is located closer to the negative electrode in a thickness direction and a second intermediate part that is located farther from the negative electrode in the thickness direction, a weight ratio of the inorganic particles to the binder in the second intermediate part is greater than a weight ratio of the inorganic particles to the binder in the first intermediate part.

### CROSS REFERENCE TO RELATED APPLICATIONS

The present application is a continuation of PCT patent application no. PCT/JP2020/033531, filed on Sep. 4, 2020, which claims priority to Japanese patent application no. JP2019-178789 filed on Sep. 30, 2019, the entire contents of which are being incorporated herein by reference.

### BACKGROUND

The present technology generally relates to a negative electrode for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery influences a battery characteristic. Accordingly, the configuration of the secondary battery has been considered in various ways.

Specifically, in order to improve durability to withstand charging and discharging, a ceramic coat layer including ceramic particles as a main component is provided on a surface of a negative electrode active material layer. In order to improve a characteristic such as a high-temperature cyclability characteristic, a covering layer including filler particles and a binder is provided on a surface of a negative electrode active material layer. In order to improve safety, a porous insulating layer including an inorganic oxide filler and a resin binder is provided on a surface of an active material layer. In order to improve safety, an organic-inorganic composite porous coat layer including inorganic particles and a binder polymer is provided on a surface of an electrode. In order to suppress gas generation upon storing at high temperatures, a separator is provided with a coating layer including an inorganic filler.

### SUMMARY

The present technology generally relates to a negative electrode for a secondary battery, and a secondary battery.

Although consideration has been given in various ways to solve problems of a secondary battery, the secondary battery has not yet achieved sufficient electrochemical performance or sufficient safety, and there is still room for improvement in terms thereof.

The present technology has been made in view of such an issue and it is an object of the technology to provide a negative electrode for a secondary battery, and a secondary battery that each make it possible to achieve both ensuring of electrochemical performance and improvement of safety.

A negative electrode for a secondary battery according to an embodiment of the present technology includes a negative electrode active material layer and a covering layer. The covering layer covers a surface of the negative electrode active material layer and includes inorganic particles and a binder. The covering layer includes a first covering part that is located closer to the negative electrode active material layer in a thickness direction and a second covering part that is located farther from the negative electrode active material layer in the thickness direction, and a weight ratio of the inorganic particles to the binder in the second covering part is greater than a weight ratio of the inorganic particles to the binder in the first covering part. The covering layer may be divided equally into the first covering part and the second covering part according to an embodiment of the present technology.

A secondary battery according to an embodiment of the present technology includes a positive electrode, a negative electrode, and an intermediate layer. The positive electrode and the negative electrode are opposed to each other with a separator interposed therebetween. The intermediate layer is disposed between the negative electrode and the separator and includes inorganic particles and a binder. The intermediate layer includes a first intermediate part that is located closer to the negative electrode in a thickness direction and a second intermediate part that is located farther from the negative electrode in the thickness direction, and a weight ratio of the inorganic particles to the binder in the second intermediate part is greater than a weight ratio of the inorganic particles to the binder in the first intermediate part. The intermediate layer may be divided equally into the first covering part and the second covering part according to an embodiment of the present technology.

According to the negative electrode for a secondary battery of an embodiment of the present technology, the covering layer including the inorganic particles and the binder covers the surface of the negative electrode active material layer. Where the covering layer is divided equally into the first covering part that is located closer to the negative electrode active material layer in the thickness direction and the second covering part that is located farther from the negative electrode active material layer in the thickness direction, the weight ratio of the inorganic particles to the binder is greater in the second covering part than in the first covering part. This makes it possible to achieve both ensuring of electrochemical performance and improvement of safety.

According to the secondary battery of an embodiment of the present technology, the intermediate layer including the inorganic particles and the binder is disposed between the negative electrode and the separator. Where the intermediate layer is divided equally into the first intermediate part that is located closer to the negative electrode in the thickness direction and the second intermediate part that is located farther from the negative electrode in the thickness direction, the weight ratio of the inorganic particles to the binder is greater in the second intermediate part than in the first intermediate part. This makes it possible to achieve both ensuring of electrochemical performance and improvement of safety.

It should be understood that effects of the technology are not necessarily limited to those described above and may include any of a series of effects described below in relation to the technology.

### BRIEF DESCRIPTION OF THE FIGURES

FIG. 1 is a perspective view of a configuration of a secondary battery according to an embodiment of the present technology.

FIG. 2 is a sectional view of a configuration of a wound electrode body illustrated in FIG. 1.

FIG. 3 is a sectional view of a configuration of a main part of the wound electrode body illustrated in FIG. 2.

FIG. 4 is a sectional view of a configuration of a negative electrode illustrated in FIG. 2.

FIG. 5 is a capacity potential curve (charge voltage Ec=4.30 V) of a secondary battery according to a reference example.

FIG. 6 is another capacity potential curve (charge voltage Ec=4.45 V) of the secondary battery according to the reference example.

FIG. 7 is a capacity potential curve (charge voltage Ec=4.38 V) of the secondary battery according to an embodiment of the present technology.

FIG. 8 is another capacity potential curve (charge voltage Ec=4.45 V) of the secondary battery according to an embodiment of the present technology.

FIG. 9 is a sectional view of a configuration of a separator in a secondary battery according to an embodiment of the present technology.

FIG. 10 is a block diagram illustrating a configuration of an application example of the secondary battery according to an embodiment, which is a battery pack including a single battery.

FIG. 11 is a block diagram illustrating a configuration of an application example of the secondary battery according to an embodiment, which is a battery pack including an assembled battery.

FIG. 12 is a block diagram illustrating a configuration of an application example of the secondary battery according to an embodiment, which is an electric vehicle.

### DETAILED DESCRIPTION

As described herein, the present disclosure will be described based on examples with reference to the drawings, but the present disclosure is not to be considered limited to the examples, and various numerical values and materials in the examples are considered by way of example.

A description is given first of a secondary battery according to an embodiment of the present technology. A negative electrode for a secondary battery according to an embodiment of the technology is a portion or a component of the secondary battery, and is thus described together below. Hereinafter, the negative electrode for a secondary battery is simply referred to as a “negative electrode”.

The secondary battery to be described herein is a secondary battery that obtains a battery capacity using insertion and extraction of an electrode reactant, and includes a positive electrode, a negative electrode, and an electrolytic solution. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is a light metal, such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

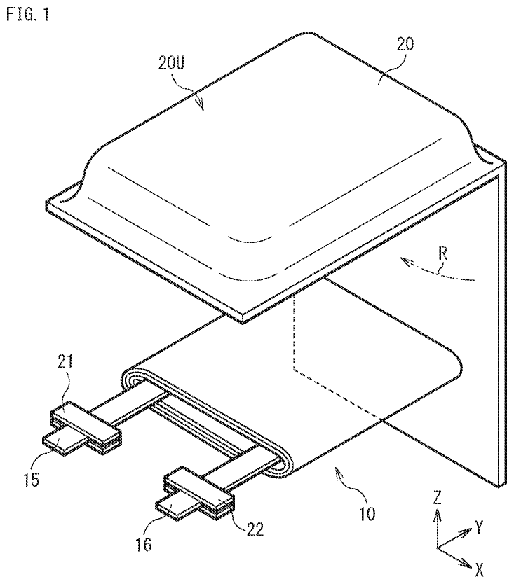

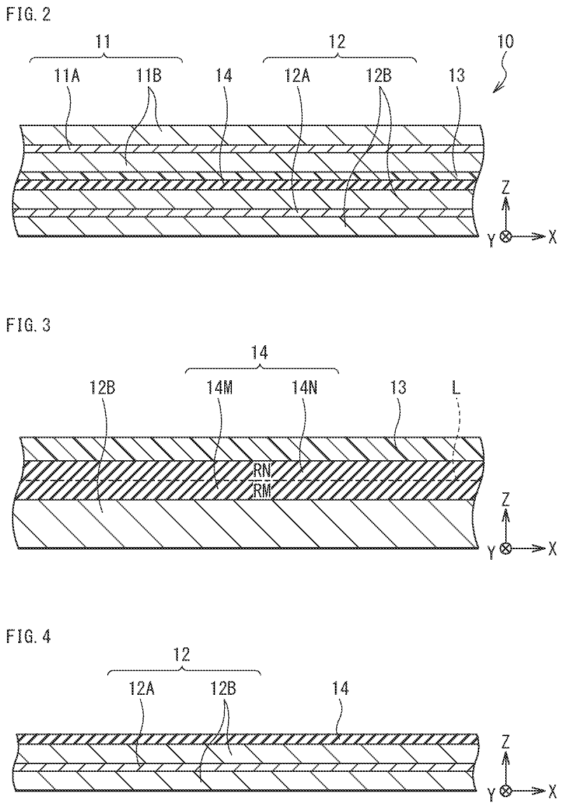

FIG. 1 illustrates a perspective configuration of the secondary battery. FIG. 2 illustrates a sectional configuration of a wound electrode body 10 illustrated in FIG. 1. FIG. 3 illustrates a sectional configuration of a main part of the wound electrode body 10 illustrated in FIG. 2.

It should be understood that FIG. 1 illustrates a state in which the wound electrode body 10 and an outer package film 20 are separated from each other. FIG. 2 illustrates only a portion of the wound electrode body 10. FIG. 3 illustrates a negative electrode active material layer 12B, a separator 13, and an intermediate layer 14 in the wound electrode body 10.

In the secondary battery, as illustrated in FIG. 1, a battery device of a wound type, i.e., the wound electrode body 10, is contained inside the outer package film 20 having a pouch shape. A positive electrode lead 15 and a negative electrode lead 16 are coupled to the wound electrode body 10. The positive electrode lead 15 and the negative electrode lead 16 are led out in respective directions that are common to each other, from inside to outside the outer package film 20.

In other words, the secondary battery described here is a secondary battery of a laminated-film type in which the outer package film 20 is used as an outer package member to contain the battery device, i.e., the wound electrode body 10 therein. The outer package film 20 has flexibility or softness.

### [Outer Package Film]

The outer package film 20 is, for example, a single film-shaped member that is foldable in a direction of an arrow R (an arrowed dash-dotted line), as illustrated in FIG. 1. The outer package film 20 has a depression part 20U to place the wound electrode body 10 therein. The depression part 20U is a so-called deep drawn part.

Specifically, the outer package film 20 is a three-layered laminated film including a fusion-bonding layer, a metal layer, and a surface protective layer that are stacked in this order from an inner side. In a state in which the outer package film 20 is folded, outer edges of the fusion-bonding layer are fusion-bonded to each other. The fusion-bonding layer includes a polymer compound such as polypropylene. The metal layer includes a metal material such as aluminum. The surface protective layer includes a polymer compound such as nylon. The number of layers of the outer package film 20 as a laminated film is not limited to three, and may be two, or four or more. The outer package film 20 is not limited to a multilayered laminated film, and may be single-layered.

A sealing film 21 is interposed between the outer package film 20 and the positive electrode lead 15. A sealing film 22 is interposed between the outer package film 20 and the negative electrode lead 16. Each of the sealing films 21 and 22 is a member that prevents entry of outside air, and includes one or more of materials having adherence to both the positive electrode lead 15 and the negative electrode lead 16, such as a polyolefin resin. Examples of the polyolefin resin include polyethylene, polypropylene, modified polyethylene, and modified polypropylene. It should be understood that one or both of the sealing films 21 and 22 may be omitted.

As illustrated in FIGS. 1 and 2, the wound electrode body 10 includes a positive electrode 11, a negative electrode 12, the separator 13, the intermediate layer 14, and an electrolytic solution. The electrolytic solution is a liquid electrolyte. The wound electrode body 10 has a structure in which the positive electrode 11 and the negative electrode 12 are stacked on each other with the separator 13 and the intermediate layer 14 interposed therebetween, and the stack of the positive electrode 11, the negative electrode 12, the separator 13, and the intermediate layer 14 is wound. Mainly, the positive electrode 11, the negative electrode 12, and the separator 13 are each impregnated with the electrolytic solution. It should be understood that FIG. 2 omits the illustration of the electrolytic solution.

As illustrated in FIG. 2, the positive electrode 11 includes a positive electrode current collector 11A, and two positive electrode active material layers 11B provided on respective opposite sides of the positive electrode current collector 11A. However, the positive electrode active material layer 11B may be provided only on one of the opposite sides of the positive electrode current collector 11A.

The positive electrode current collector 11A includes one or more of electrically conductive materials including, without limitation, aluminum, nickel, and stainless steel. The positive electrode active material layer 11B includes one or more of positive electrode active materials into which lithium is insertable and from which lithium is extractable, that is, materials that allow lithium to be inserted thereinto and extracted therefrom in an ionic state. The positive electrode active material layer 11B may further include, without limitation, a positive electrode binder and a positive electrode conductor.

Although not particularly limited in kind, the positive electrode active material is a lithium-containing compound such as a lithium-containing transition metal compound. The lithium-containing transition metal compound includes lithium and one or more of transition metal elements, and may further include one or more of other elements. The other elements may be any elements other than transition metal elements, and are not particularly limited in kind. In particular, the other elements are preferably those belong to groups 2 to 15 in the long period periodic table of elements. It should be understood that the lithium-containing transition metal compound may be an oxide or may be any other compound such as a phosphoric acid compound, a silicic acid compound, or a boric acid compound.

Specific examples of the oxide include LiNiO₂, LiCoO₂, LiCO_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. The positive electrode conductor may be a material such as a metal material or an electrically conductive polymer as long as the material has an electrically conductive property.

As illustrated in FIG. 2, the negative electrode 12 includes a negative electrode current collector 12A, and a negative electrode active material layer 12B provided on each of opposite sides of the negative electrode current collector 12A. However, the negative electrode active material layer 12B may be provided only on one of the opposite sides of the negative electrode current collector 12A.

The negative electrode current collector 12A includes one or more of electrically conductive materials including, without limitation, copper, aluminum, nickel, and stainless steel. The negative electrode active material layer 12B includes one or more of negative electrode active materials into which lithium is insertable and from which lithium is extractable, that is, materials that allow lithium to be inserted thereinto and extracted therefrom in an ionic state. The negative electrode active material layer 12B may further include, without limitation, a negative electrode binder and a negative electrode conductor. Details of the negative electrode binder and the negative electrode conductor are similar to the details of the positive electrode binder and the positive electrode conductor described above, respectively.

The negative electrode active material is not particularly limited in kind, and examples thereof include a carbon material and a metal-based material. Examples of the carbon material include graphitizable carbon, non-graphitizable carbon, and graphite. The metal-based material is a material including one or more among metal elements and metalloid elements that are each able to form an alloy with lithium. Specifically, the metal-based material includes one or more of elements including, without limitation, silicon and tin, as a constituent element or constituent elements. The metal-based material may be, for example, a simple substance, an alloy, a compound, or a mixture of two or more thereof.

Specific examples of the metal-based material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2 or 0.2<v<1.4), LiSiO, SnO_{w} (0<w≤2), SnSiO₃, LiSnO, and Mg₂Sn.

### (Separator)

As illustrated in FIG. 2, the separator 13 is interposed between the positive electrode 11 and the negative electrode 12. The positive electrode 11 and the negative electrode 12 are thus opposed to each other with the separator 13 interposed therebetween.

The separator 13 is an insulating porous film that allows lithium to pass therethrough while preventing a contact or a short-circuit between the positive electrode 11 and the negative electrode 12. The porous film may be single-layered or multilayered. The porous film includes one or more of polymer compounds including, without limitation, polytetrafluoroethylene, polypropylene, and polyethylene.

Although not particularly limited, an air permeability of the separator 13 is preferably within a range from 100 sec/cm³ (=100 sec/ml) to 1000 sec/cm³ (=1000 sec/ml) both inclusive, in particular. A reason for this is that this secures permeability to lithium and thus improves mobility of lithium between the positive electrode 11 and the negative electrode 12 during insertion and extraction.

It should be understood that the air permeability of the separator 13 described here is not the air permeability of the separator 13 to be used in a process of manufacturing the secondary battery (i.e., the separator 13 before being adhered to the negative electrode 12), but the air permeability of the separator 13 collected from the completed secondary battery (i.e., the separator 13 after being adhered to the negative electrode 12). A procedure to measure the air permeability is as described below. First, the secondary battery is disassembled to thereby collect the separator 13. Thereafter, the air permeability of the separator 13 is measured at each of ten different locations by means of an air permeability tester (a Gurley type densometer available from Toyo Seiki Co., Ltd.). Lastly, an average value of ten air permeabilities measured at the ten respective locations is calculated as the air permeability of the separator 13.

The air permeability of the separator 13 is adjustable by varying a condition such as a treatment temperature at which an activation treatment is to be performed in the process of manufacturing the secondary battery, that is, in an activation process described later.

Although not particularly limited, a thickness of the separator 13 is preferably within a range from 3 μm to 12 μm both inclusive, in particular. A reason for this is that such a thickness allows for compatibility between energy density of the secondary battery and physical strength of the separator 13. The thickness here is an average value of ten thicknesses measured at ten respective different locations.

The intermediate layer 14 is disposed between the negative electrode 12 and the separator 13, and is thus adhered to both the negative electrode 12 and the separator 13. The intermediate layer 14 includes inorganic particles and an intermediate binder. The intermediate binder is a binder included in the intermediate layer 14. Details of the intermediate binder are similar to the details of the positive electrode binder. It should be understood that the intermediate layer 14 may further include one or more of materials including, without limitation, any additives on an as-needed basis.

In the intermediate layer 14, as will be described later, a distribution of the inorganic particles is optimized; more specifically, a dispersion state of the inorganic particles is set to allow a weight ratio RN to be greater than a weight ratio RM. This improves safety of the secondary battery while securing electrochemical performance of the secondary battery. A detailed description will be given later of an advantage that is brought about by the optimization of the distribution of the inorganic particles described here.

The inorganic particles include one or more of inorganic materials. Although the inorganic material is not particularly limited in kind, examples thereof include a metal oxide, a metal nitride, and a metal hydroxide.

Specific examples of the metal oxide include aluminum oxide, silicon oxide, titanium oxide, magnesium oxide, and zirconium oxide. Specific examples of the metal nitride include aluminum nitride. Specific examples of the metal hydroxide include magnesium hydroxide.

The inorganic material preferably includes one or more among the metal oxides and metal hydroxides, in particular, and more preferably includes one or more of materials including, without limitation, aluminum oxide and magnesium hydroxide. A reason for this is that this further improves the safety while securing the electrochemical performance.

Although not particularly limited, a thickness of the intermediate layer 14 is preferably within a range from 0.1 μm to 5 μm both inclusive, in particular. A reason for this is that such a thickness reduces inhibition of insertion and extraction of lithium into and from the negative electrode 12, thus allowing the above-described advantage to be achieved while securing insertion and extraction of lithium. The thickness of the intermediate layer 14 is a dimension in a Z-axis direction in FIGS. 2 and 3, that is, a dimension in a direction in which the positive electrode 11 and the negative electrode 12 are opposed to each other with the separator 13 interposed therebetween.

A procedure to calculate the thickness of the intermediate layer 14 is as described below. First, the secondary battery is disassembled to thereby collect the negative electrode 12. Thereafter, a section of the negative electrode 12 (FIG. 3) is observed by means of a microscope such as a scanning electron microscope (SEM). Observation conditions including magnification may be freely chosen. Thereafter, the thickness of the intermediate layer 14 is measured at each of ten different locations on the basis of a result of the observation (a micrograph) of the section of the negative electrode 12. Lastly, an average value of ten thicknesses measured at the ten respective locations is calculated as the thickness of the intermediate layer 14.

A detailed description will now be given of the distribution of the inorganic particles described above. In the intermediate layer 14 described here, the distribution of the inorganic particles, that is, the dispersion state (a weight ratio R) of the inorganic particles is optimized as described below.

Specifically, as illustrated in FIG. 3, the intermediate layer 14 is divided equally into two parts in a thickness direction (the Z-axis direction) of the intermediate layer 14. Thus, the intermediate layer 14 is divided into a lower layer 14M and an upper layer 14N. The lower layer 14M corresponds to a first intermediate part located closer to the negative electrode 12 (the negative electrode active material layer 12B), in other words, a lower part of the intermediate layer 14. The upper layer 14N corresponds to a second intermediate part located farther from the negative electrode 12, in other words, an upper part of the intermediate layer 14. In FIG. 3, a dashed line L represents a border between the lower layer 14M and the upper layer 14N.

The lower layer 14M and the upper layer 14N each include the inorganic particles and the intermediate binder. Accordingly, the weight ratio R is defined in the lower layer 14M as the weight ratio RM, and is defined in the upper layer 14N as the weight ratio RN. The weight ratio RM is a ratio of a weight M2 of the inorganic particles to a weight M1 of the intermediate binder in the lower layer 14M, and is therefore calculated by the following formula: RM=M2/M1. The weight ratio RN is a ratio of a weight M4 of the inorganic particles to a weight M3 of the intermediate binder in the upper layer 14N, and is therefore calculated by the following formula: RN=M4/M3.

In this case, the weight ratio RN is set to be greater than the weight ratio RM. In other words, a distribution amount, i.e., a dispersion amount, of the inorganic particles is greater in the upper layer 14N than in the lower layer 14M. This optimizes the distribution of the inorganic particles in the intermediate layer 14, thus improving the safety of the secondary battery while securing the electrochemical performance of the secondary battery as described above.

A plurality of formation methods is possible for forming the intermediate layer 14 to cause the weight ratio RN to be greater than the weight ratio RM. Such formation methods of the intermediate layer 14 will be described in detail later.

Respective ranges of the weight ratios RM and RN are not particularly limited. The weight ratio RM is preferably within a range from 0.1 to 10 both inclusive, and the weight ratio RN is preferably within a range from 0.2 to 20 both inclusive, in particular. A reason for this is that this optimizes the respective ranges of the weight ratios RM and RN, thus allowing for sufficient improvement in safety of the secondary battery while securing the electrochemical performance of the secondary battery.

A procedure to calculate the weight ratio RN is as described below. First, the secondary battery is disassembled to thereby collect the intermediate layer 14. Thereafter, a portion of the intermediate layer 14 is cut by means of cutting equipment (Surface and Interfacial Cutting Analysis System (SAICAS) NN, a diagonal cutting apparatus available from Daipla Wintes Co., Ltd., “SAICAS” being a registered trademark) to thereby separate the upper layer 14N from the lower layer 14M. Thereafter, the upper layer 14N is analyzed by means of a simultaneous thermogravimeter-differential thermal analyzer (TG-DTA STA7000 available from Hitachi High-Tech Science Corporation) to thereby measure each of the weight M3 of the intermediate binder and the weight M4 of the inorganic particles. In this case, the temperature is changed within a range from room temperature (=23° C.) to 1000° C. both inclusive, with a temperature rise rate set to 10° C./min. Lastly, the weight ratio RN of the upper layer 14N is calculated on the basis of the weight M3 of the intermediate binder and the weight M4 of the inorganic particles.

A procedure to calculate the weight ratio RM is similar to the above-described procedure to calculate the weight ratio RN, except that the lower layer 14M is used instead of the upper layer 14N.

The electrolytic solution includes a solvent and an electrolyte salt. The electrolytic solution may include only one solvent or may include two or more solvents. The electrolytic solution may include only one electrolyte salt or may include two or more electrolyte salts.

The solvent includes a non-aqueous solvent (an organic solvent). An electrolytic solution including a non-aqueous solvent is a so-called non-aqueous electrolytic solution.

Examples of the non-aqueous solvent include esters and ethers. More specific examples of the non-aqueous solvent include a carbonic-acid-ester-based compound, a carboxylic-acid-ester-based compound, and a lactone-based compound.

Examples of the carbonic-acid-ester-based compound include a cyclic carbonic acid ester and a chain carbonic acid ester. Examples of the cyclic carbonic acid ester include ethylene carbonate and propylene carbonate. Examples of the chain carbonic acid ester include dimethyl carbonate, diethyl carbonate, and methyl ethyl carbonate. Examples of the carboxylic-acid-ester-based compound include ethyl acetate, ethyl propionate, and ethyl trimethyl acetate. Examples of the lactone-based compound include γ-butyrolactone and γ-valerolactone. Examples of the ethers other than the lactone-based compounds described above include 1,2-dimethoxy ethane, tetrahydrofuran, 1,3-dioxolane, and 1,4-dioxane.

Further, examples of the non-aqueous solvent include an unsaturated cyclic carbonic acid ester, a halogenated carbonic acid ester, a sulfonic acid ester, a phosphoric acid ester, an acid anhydride, a nitrile compound, and an isocyanate compound. A reason for this is that chemical stability of the electrolytic solution improves.

Specific examples of the unsaturated cyclic carbonic acid ester include vinylene carbonate, vinylethylene carbonate, and methylene ethylene carbonate. Examples of the halogenated carbonic acid ester include fluoroethylene carbonate and difluoroethylene carbonate. Examples of the sulfonic acid ester include 1,3-propane sultone. Examples of the phosphoric acid ester include trimethyl phosphate. Examples of the acid anhydride include a cyclic carboxylic acid anhydride, a cyclic disulfonic acid anhydride, and a cyclic carboxylic acid sulfonic acid anhydride. Examples of the cyclic carboxylic acid anhydride include succinic anhydride, glutaric anhydride, and maleic anhydride. Examples of the cyclic disulfonic acid anhydride include ethane disulfonic anhydride and propane disulfonic anhydride. Examples of the cyclic carboxylic acid sulfonic acid anhydride include sulfobenzoic anhydride, sulfopropionic anhydride, and sulfobutyric anhydride. Examples of the nitrile compound include acetonitrile and succinonitrile. Examples of the isocyanate compound include hexamethylene diisocyanate.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), and lithium bis(oxalato)borate (LiB(C₂O₄)₂). Although not particularly limited, a content of the electrolyte salt is within a range from 0.3 mol/kg to 3.0 mol/kg both inclusive with respect to the solvent. A reason for this is that a high ion conductivity is obtainable.

The positive electrode lead 15 is coupled to the positive electrode 11 (the positive electrode current collector 11A), and the negative electrode lead 16 is coupled to the negative electrode 12 (the negative electrode current collector 12A). The positive electrode lead 15 includes a material similar to that included in the positive electrode current collector 11A. The negative electrode lead 16 includes a material similar to that included in the negative electrode current collector 12A. The positive electrode lead 15 and the negative electrode lead 16 each have a shape such as a thin plate shape or a meshed shape.

It is sufficient that the intermediate layer 14 is interposed between the negative electrode 12 and the separator 13, and therefore a joining relationship between the intermediate layer 14 and another component is not particularly limited.

FIG. 4 illustrates a sectional configuration of the negative electrode 12 illustrated in FIG. 2, and corresponds to FIG. 3. It should be understood that the negative electrode 12 illustrated in FIG. 4 is that to be used in the process of manufacturing the secondary battery. In the following, FIGS. 2 and 3 will be referred to as necessary.

Here, the intermediate layer 14 is provided on a surface of the negative electrode 12 (the negative electrode active material layer 12B) on a side opposed to the separator 13. Accordingly, the intermediate layer 14 is joined to the negative electrode 12, thus serving as a covering layer covering the surface of the negative electrode active material layer 12B. The intermediate layer 14 serving as the covering layer includes the lower layer 14M and the upper layer 14N as described above. The lower layer 14M corresponds to a first covering part. The upper layer 14N corresponds to a second covering part.

In this case, the intermediate layer 14 is provided integrally with the negative electrode 12. This secures adherence of the intermediate layer 14 to the negative electrode 12. Further, owing to the negative electrode 12 and the intermediate layer 14 constituting a single member as a whole, handleability of the negative electrode 12 and the intermediate layer 14 improves as compared with a case where the negative electrode 12 and the intermediate layer 14 are separated from each other, i.e., a case where the negative electrode 12 and the intermediate layer 14 are two separate members. This makes it easier to manufacture the secondary battery.

Although not particularly limited, a coverage of the intermediate layer 14 is preferably within a range from 20% to 100%, both inclusive, of the surface of the negative electrode active material layer 12B, in particular. A reason for this is that such a coverage allows for sufficient adhesion of the negative electrode 12 to the separator 13, thus allowing for sufficient improvement in electrochemical performance of the secondary battery and also sufficient improvement in safety of the secondary battery.

The coverage is adjustable by changing, for example, respective solids concentrations of a first intermediate mixture slurry and a second intermediate mixture slurry described later in a process of forming the intermediate layer 14.

A procedure to measure the coverage of the intermediate layer 14 is as described below. First, the secondary battery is disassembled to thereby collect the negative electrode 12 with the intermediate layer 14. Thereafter, elemental analysis is performed on ten different locations in a predetermined analysis range or analysis area of the surface of the negative electrode active material layer 12B by means of an energy dispersive X-ray spectrometer (EDX) to thereby identify a formation range or formation area of the intermediate layer 14. This elemental analysis is performed for a constituent element of the inorganic particles included in the intermediate layer 14. Specifically, in a case where the inorganic particles include magnesium hydroxide, the elemental analysis is performed for magnesium. Thereafter, the following is calculated: coverage (%)=(formation area of the intermediate layer 14/analysis area of the negative electrode active material layer 12B)×100. For example, EDX-7000, an energy dispersive X-ray fluorescence spectrometer available from Shimadzu Corporation is usable as the EDX. An analysis condition is that a degree of vacuum is within a range from 10⁻⁵ to 10⁻⁶ both inclusive, although not particularly limited thereto. Lastly, an average value of ten coverages calculated for the ten respective locations is calculated as the coverage of the intermediate layer 14. The value of the coverage is rounded off to the nearest whole number.

In the case where the intermediate layer 14 is provided on the surface of the negative electrode 12, the negative electrode 12 is adhered to the separator 13 via the intermediate layer 14. Although not particularly limited, an adhesion strength of the negative electrode 12 to the separator 13 is preferably within a range from 3 mN/mm to 30 mN/mm both inclusive, in particular. A reason for this is that such a strength allows for uniform adhesion of the negative electrode 12 to the separator 13, thus suppressing variations in distance between the negative electrode 12 and the separator 13 and also variations in electrical resistance of the negative electrode 12.

A procedure to measure the adhesion strength of the negative electrode 12 is as described below. First, the secondary battery is disassembled to thereby collect a staked body including the negative electrode 12, the separator 13, and the intermediate layer 14 stacked on each other. Thereafter, the intermediate layer 14 is peeled off in a direction at 180° with respect to the separator 13 by means of a tensile tester (Tensilon RTF, a universal testing instrument available from A&D Company, Limited) to thereby measure the adhesion strength of the negative electrode 12 to the separator 13. Lastly, an average value of ten adhesion strengths calculated at ten respective locations is calculated as the adhesion strength of the negative electrode 12. The value of the adhesion strength is rounded off to the nearest whole number.

To cause the secondary battery to be chargeable and dischargeable under a high charge voltage condition, the negative electrode 12 preferably satisfies predetermined configuration conditions and predetermined physical property conditions described below.

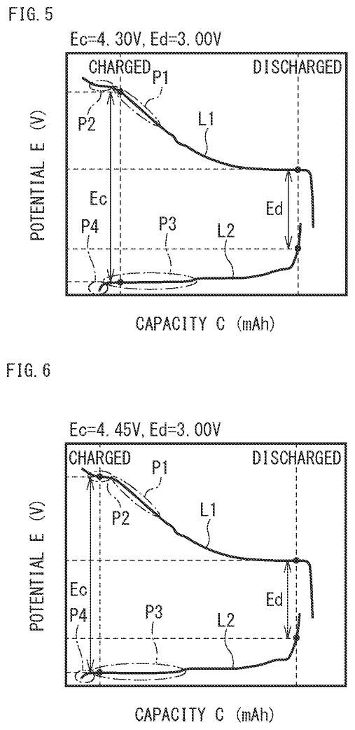

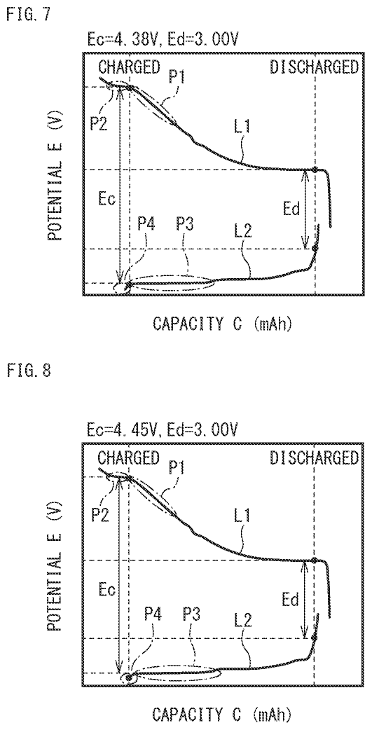

FIGS. 5 and 6 each represent a capacity potential curve related to a secondary battery according to a reference example for the secondary battery according to the present embodiment. FIGS. 7 and 8 each represent a capacity potential curve related to the secondary battery according to the present embodiment.

In each of FIGS. 5 to 8, a horizontal axis represents a capacity C (mAh) and a vertical axis represents a potential E (V). The potential E is an open circuit potential to be measured with lithium metal as a reference electrode, i.e., a potential versus a lithium reference electrode. FIGS. 5 to 8 each represent a capacity potential curve L1 of the positive electrode 11 and a capacity potential curve L2 of the negative electrode 12. It should be understood that a position of a dashed line indicated as “charged” represents a full charge state, and a position of a dashed line indicated as “discharged” represents a full discharge state.

A charge voltage Ec (V) and a discharge voltage Ed (V) are set as follows. In FIG. 5, the charge voltage Ec is set to 4.30 V and the discharge voltage Ed is set to 3.00 V. In FIG. 6, the charge voltage Ec is set to 4.45 V and the discharge voltage Ed is set to 3.00 V. In FIG. 7, the charge voltage Ec is set to 4.38 V and the discharge voltage Ed is set to 3.00 V. In FIG. 8, the charge voltage Ec is set to 4.45 V and the discharge voltage Ed is set to 3.00 V. Upon charging and discharging, the secondary battery is charged until a battery voltage (a closed circuit voltage) reaches the charge voltage Ec and then discharged until the battery voltage reaches the discharge voltage Ed.

In the following, a description is given of a premise, i.e., the configuration conditions, for describing a charge and discharge principle and the physical property conditions of the secondary battery according to the present embodiment, and thereafter, a description is given of the charge and discharge principle and also the physical property conditions for achieving the charge and discharge principle.

Here, the positive electrode active material of the positive electrode 11, i.e., a lithium-containing transition metal compound, includes one or more of lithium-cobalt composite oxides having a layered rock-salt crystal structure (hereinafter referred to as “layered rock-salt lithium-cobalt composite oxides”) that are represented by Formula (1) below. A reason for this is that a high energy density is stably achievable.

LiₓCo_{1-y}M_{y}O_{2-z}X_{z} (1)

where:
M is at least one of titanium (Ti), vanadium (V), chromium (Cr), manganese (Mn), iron (Fe), nickel (Ni), copper (Cu), sodium (Na), magnesium (Mg), aluminum (Al), silicon (Si), tin (Sn), potassium (K), calcium (Ca), zinc (Zn), gallium (Ga), strontium (Sr), yttrium (Y), zirconium (Zr), niobium (Nb), molybdenum (Mo), barium (Ba), lanthanum (La), tungsten (W), or boron (B); X is at least one of fluorine (F), chlorine (Cl), bromine (Br), iodine (I), or sulfur (S); and
x, y, and z satisfy 0.8<x<1.2, 0<y≤0.15, and 0≤z<0.05.

It should be understood that a composition of lithium differs depending on a charging state and a discharging state. A value of x included in Formula (1) represents a value in a state in which the positive electrode 11 taken out of the secondary battery has been discharged until the potential has reached 3.0 V (versus a lithium reference electrode).

As is apparent from Formula (1), the layered rock-salt lithium-cobalt composite oxide is a cobalt-based lithium composite oxide. The layered rock-salt lithium-cobalt composite oxide may further include one or more of first additional elements (M), and may further include one or more of second additional elements (X). Details of each of the first additional element (M) and the second additional element (X) are as described above.

In other words, as is apparent from a value range that y can take, the layered rock-salt lithium-cobalt composite oxide may include no first additional element (M). Similarly, as is apparent from a value range that z can take, the layered rock-salt lithium-cobalt composite oxide may include no second additional element (X).

The layered rock-salt lithium-cobalt composite oxide is not particularly limited in kind and may be any compound represented by Formula (1). Specific examples of the layered rock-salt lithium-cobalt composite oxide include LiCoO₂, LiCo_{0.98}Al_{0.02}O₂, LiCo_{0.98}Mn_{0.02}O₂, and LiCo_{0.98}Mg_{0.02}O₂.

The negative electrode active material of the negative electrode 12, i.e., a carbon material, includes graphite. The graphite is not particularly limited in kind. The graphite may be artificial graphite, natural graphite, or both.

To achieve an improved energy density of the secondary battery including the positive electrode 11 in which the positive electrode active material is the layered rock-salt lithium-cobalt composite oxide and the negative electrode 12 in which the negative electrode active material is graphite, it is conceivable to increase the charge voltage Ec, i.e., a so-called end-of-charge voltage. Increasing the charge voltage Ec raises the potential E of the positive electrode 11 in an end stage of charging, and eventually, at an end of charging. This raises a use range of the potential E, i.e., a potential range to be used in the positive electrode 11 during charging.

In a case where the layered rock-salt lithium-cobalt composite oxide is used as the positive electrode active material, a potential constant region P2 associated with a phase transition (O3/H1-3 transition) generally exists. Increasing the charge voltage Ec also increases the potential E of the positive electrode 11 in the end stage of charging, thus causing the potential E of the positive electrode 11 to reach inside the potential constant region P2 described above. Accordingly, the capacity potential curve L1 of the positive electrode 11 has a potential varying region P1 and the potential constant region P2 as indicated in FIGS. 5 to 8. The potential varying region P1 is a region in which the potential E varies as the capacity C varies. The potential constant region P2 is a region in the capacity potential curve located to the left of the potential constant region P1 and is a region in which the potential E hardly varies even if the capacity C varies as a result of the phase transition.

If the secondary battery including the layered rock-salt lithium-cobalt composite oxide is charged and discharged in such a manner that the potential E of the positive electrode 11 reaches inside the potential constant region P2 associated with the phase transition, or the potential E of the positive electrode 11 passes through the potential constant region P2 associated with the phase transition, there is tendency that a capacity loss easily occurs and gas generation also easily occurs. Such a tendency is noticeable in a case where the secondary battery is used and stored in a high temperature environment. In particular, if the charge voltage Ec is 4.38 V or higher, it becomes easier for the potential E of the positive electrode 11 to reach the potential constant region P2 associated with the phase transition, or it becomes easier for the potential E of the positive electrode 11 to pass through the potential constant region P2 associated with the phase transition.

In contrast, if the charge voltage Ec is increased in a case where graphite is used as the negative electrode active material, a two-phase coexistence reaction of an intercalation compound stage 1 and an intercalation compound stage 2 proceeds in the graphite. As a result, the capacity potential curve L2 of the negative electrode 12 has a potential constant region P3 as indicated in FIGS. 5 to 8. The potential constant region P3 is a region in which the potential E hardly varies even if the capacity C varies in association with the two-phase coexistence reaction. The potential E of the negative electrode 12 in the potential constant region P3 is about 90 mV to about 100 mV.

It should be understood that if the charge voltage Ec is further increased, the potential E of the negative electrode 12 exceeds the potential constant region P3, and thus the potential E varies markedly. In association with the increase in the charge voltage Ec that causes the potential E to exceed the potential constant region P3, the capacity potential curve L2 of the negative electrode 12 has a potential varying region P4, as indicated in FIGS. 5 to 8. In FIGS. 5 to 8, the potential varying region P4 is a region in the capacity potential curve located to the left of the potential constant region P3 and is a region in which the potential E varies (decreases) markedly if the capacity C varies. The potential E of the negative electrode 12 in the potential varying region P4 is lower than about 90 mV.

In the secondary battery according to the present embodiment in which the positive electrode 11 includes the positive electrode active material (the layered rock-salt lithium-cobalt composite oxide) and the negative electrode 12 includes the negative electrode active material (graphite), charging and discharging are performed as described below on the basis of the premise described above. In the following, the charge and discharge principle of the secondary battery according to the present embodiment (FIGS. 7 and 8) will be described in comparison with the charge and discharge principle of the secondary battery according to the reference example (FIGS. 5 and 6).

In the secondary battery according to the reference example, as indicated in FIG. 5, the potential E of the negative electrode 12 at the end of charging (charge voltage Ec=4.30 V) is set to cause the charging to be completed in the potential constant region P3, in order to prevent a battery capacity from decreasing due to precipitation of lithium metal on the negative electrode 12.

However, in the secondary battery according to the reference example, in a case where the charge voltage Ec is increased to 4.38 V or higher, more specifically, to 4.45 V, the potential E of the positive electrode 11 reaches 4.50 V or higher as indicated in FIG. 6 in association with the increase in the potential E of the negative electrode 12 at the end of charging. As a result, the potential E of the positive electrode 11 at the end of charging (charge voltage Ec=4.45 V) reaches the potential constant region P2 associated with the phase transition or passes through the potential constant region P2 associated with the phase transition.

Thus, in the secondary battery according to the reference example, the increase in the charge voltage Ec to 4.38 V or higher makes it easier for the potential E of the positive electrode 11 to reach the potential constant region P2 associated with the phase transition, or for the potential E of the positive electrode 11 to pass through the potential constant region P2 associated with the phase transition. This generates a tendency that the capacity loss easily occurs and the gas generation also easily occurs, making it easier for a battery characteristic to deteriorate. As described above, the tendency that the battery characteristic easily deteriorates is noticeable in the case where the secondary battery is used and stored in a high temperature environment.

Moreover, in the secondary battery according to the reference example, the battery capacity is easily influenced by, for example, an active material ratio, i.e., a ratio between the amount of the positive electrode active material and the amount of the negative electrode active material, and the charge voltage Ec. Thus, the battery capacity easily varies in association with, for example, variations in the active material ratio (amount) and a setting error of the charge voltage Ec by a charging device. Accordingly, the variation in the capacity C of the positive electrode 11 makes it easier for the potential E of the positive electrode 11 to reach the potential constant region P2 associated with the phase transition, or the potential E of the positive electrode 11 to pass through the potential constant region P2 associated with phase transition. As a result, the battery capacity easily varies, and an operable time of, for example, equipment or an apparatus that operates using the secondary battery as a power source is shortened due to decrease in the battery capacity. In addition, if the battery capacity varies, lithium metal is generated on the negative electrode 12 more easily.

In contrast, in the secondary battery according to the present embodiment, the potential E of the negative electrode 12 is set to help to prevent the potential E of the positive electrode 11 (the layered rock-salt lithium-cobalt composite oxide) from reaching the potential constant region P2 associated with the phase transition or the potential E of the positive electrode 11 from passing through the potential constant region P2 associated with the phase transition, and also to suppress the precipitation of lithium metal on the negative electrode 12. Specifically, as indicated in FIG. 7, the potential E of the negative electrode 12 at the end of charging (charge voltage Ec=4.38 V) is set to cause the charging not to be completed in the potential constant region P3 but to be completed in the potential varying region P4. Further, as indicated in FIG. 8, the potential E of the negative electrode 12 at the end of charging (charge voltage Ec=4.45 V) is similarly set to cause the charging not to be completed in the potential constant region P3 but to be completed in the potential varying region P4.

In this case, because the potential E of the negative electrode 12 at the end of charging decreases, the potential E of the positive electrode 11 at the end of charging also decreases. Specifically, in the secondary battery according to the present embodiment, in association with the decrease in the potential E of the negative electrode 12 at the end of charging, the potential E of the positive electrode 11 does not reach 4.50 V or above even if the charge voltage Ec is increased to 4.38 V or higher, more specifically to 4.45 V, as indicated in FIGS. 7 and 8. Thus, the potential E of the positive electrode 11 at the end of charging (charge voltage Ec=4.38 V or 4.45 V) is set not to reach the potential constant region P2 associated with the phase transition, or not to pass through the potential constant region P2 associated with the phase transition.

Upon charging, as is apparent from FIGS. 7 and 8, when the secondary battery is charged up to the charge voltage Ec of 4.38 V or higher, the potential E of the negative electrode 12 markedly decreases in the potential varying region P4, and thus a charging reaction is completed. Thus, the potential E of the positive electrode 11 is controlled at the end stage of charging as described above. This prevents the potential E of the positive electrode 11 from easily reaching the potential constant region P2 associated with the phase transition, or prevents the potential E of the positive electrode 11 from easily passing through the potential constant region P2 associated with the phase transition. In addition, if the potential E of the negative electrode 12 markedly decreases in the potential varying region P4, the charging reaction is immediately terminated. This prevents the charging reaction from proceeding to an extent where the precipitation of lithium metal occurs on the negative electrode 12.

Accordingly, in the secondary battery according to the present embodiment, even if the charge voltage Ec is increased to 4.38 V or higher, the potential E of the positive electrode 11 is prevented from easily reaching the potential constant region P2 associated with the phase transition, or the potential E of the positive electrode 11 is prevented from easily passing through the potential constant region P2 associated with the phase transition. This generates a tendency that the capacity loss is suppressed and the gas generation is also suppressed. In addition, even if the charge voltage Ec is increased to 4.38 V or higher, the precipitation of lithium metal on the negative electrode 12 is suppressed, and a decrease in the battery capacity is thus suppressed.

Moreover, in the secondary battery according to the present embodiment, the battery capacity is less influenced by, for example, an active material ratio and the charge voltage Ec. This helps to suppress variation in the battery capacity, and secures the operable time of, for example, equipment or an apparatus that operates using the secondary battery as a power source. In addition, even if the battery capacity varies, generation of lithium metal is suppressed on the negative electrode 12.

In the secondary battery according to the present embodiment, two physical property conditions described below are satisfied in order to achieve the charge and discharge principle described above.

Firstly, a state in which the secondary battery is charged with a constant voltage of a closed circuit voltage (OCV (Open Circuit Voltage)) of 4.38 V or higher for 24 hours is referred to as a full charge state. The potential E of the negative electrode 12 measured in the secondary battery in the full charge state, i.e., a negative electrode potential Ef, is within a range from 19 mV to 86 mV both inclusive. It should be understood that a value of a current at the time of charging the secondary battery until the closed circuit voltage reaches 4.38 V or higher is not particularly limited, and may thus be set to any value.

That is, as described above, the potential E of the negative electrode 12 is set to cause the charging not to be completed in the potential constant region P3 but to be completed in the potential varying region P4. Accordingly, if the secondary battery is charged to the full charge state, the negative electrode potential Ef becomes lower in a case where the charging is completed in the potential varying region P4 than in a case where the charging is completed in the potential constant region P3. Thus, the negative electrode potential Ef becomes lower than about 90 mV, and more specifically, falls within the range from 19 mV to 86 mV both inclusive, as described above.

Secondly, a discharge capacity obtained when the secondary battery is discharged with a constant current from the full charge state until the closed circuit voltage reaches 3.00 V and thereafter the secondary battery is discharged with a constant voltage of the closed circuit voltage of 3.00 V for 24 hours is referred to as a maximum discharge capacity (mAh). In this case, when the secondary battery is discharged from the full charge state by a capacity corresponding to 1% of the maximum discharge capacity, a variation of the potential E of the negative electrode 12, i.e., a negative electrode potential variation Ev, represented by Formula (2) below is 1 mV or greater. As is apparent from Formula (2), the negative electrode potential variation Ev is a difference between a potential E1 (a first negative electrode potential) and a potential E2 (a second negative electrode potential). It should be understood that the current value at the time of discharging the secondary battery from the full charge state until the closed circuit voltage reaches 3.00 V is not particularly limited and may be set to any value that falls within a typical range, because the secondary battery is discharged with a constant voltage for 24 hours.

Negative electrode potential variation Ev (mV)=potential E2 (mV)−potential E1 (mV) (2)

where:
the potential E1 is an open circuit potential (versus a lithium reference electrode) of the negative electrode 12 measured in the secondary battery in the full charge state; and
the potential E2 is an open circuit potential (versus a lithium reference electrode) of the negative electrode 12 measured in the secondary battery in a state in which the secondary battery is discharged from the full charge state by the capacity corresponding to 1% of the maximum discharge capacity.

That is, as described above, in a case where the potential E of the negative electrode 12 is set to cause the charging to be completed in the potential varying region P4, the potential E of the negative electrode 12 increases markedly upon discharging the secondary battery in the full charge state by the capacity corresponding to 1% of the maximum discharge capacity, as is apparent from FIGS. 7 and 8. Thus, the potential E of the negative electrode 12 after the discharging, i.e., the potential E2, sufficiently increases as compared with the potential E of the negative electrode 12 before the discharging (the full charge state), i.e., the potential E1. Accordingly, the negative electrode potential variation Ev, i.e., the difference between the potential E1 and the potential E2, is 1 mV or greater as described above.

The secondary battery operates as described below. Upon charging, in the wound electrode body 10, lithium is extracted from the positive electrode 11, and the extracted lithium is inserted into the negative electrode 12 via the electrolytic solution. Upon discharging, in the wound electrode body 10, lithium is extracted from the negative electrode 12, and the extracted lithium is inserted into the positive electrode 11 via the electrolytic solution. Upon charging and discharging, lithium is inserted and extracted in an ionic state.

In a case of manufacturing the secondary battery, the following processes are performed by a procedure described below: a process of fabricating the positive electrode 11, a process of fabricating the negative electrode 12, a process of forming the intermediate layer 14, a process of preparing the electrolytic solution, a process of assembling the secondary battery, and an activation process.

First, the positive electrode active material is mixed with materials including, without limitation, the positive electrode binder and the positive electrode conductor on an as-needed basis to thereby obtain a positive electrode mixture. Thereafter, the positive electrode mixture is put into a solvent such as an organic solvent to thereby prepare a paste positive electrode mixture slurry. Lastly, the positive electrode mixture slurry is applied on opposite sides of the positive electrode current collector 11A to thereby form the positive electrode active material layers 11B. Thereafter, the positive electrode active material layers 11B may be compression-molded by means of a machine such as a roll pressing machine. In this case, the positive electrode active material layers 11B may be heated. The positive electrode active material layers 11B may be compression-molded multiple times. In this manner, the positive electrode active material layers 11B are formed on the respective opposite sides of the positive electrode current collector 11A. Thus, the positive electrode 11 is fabricated.

The negative electrode active material layers 12B are formed on respective opposite sides of the negative electrode current collector 12A by a procedure similar to the fabrication procedure of the positive electrode 11 described above. Specifically, the negative electrode active material is mixed with materials including, without limitation, the negative electrode binder and the negative electrode conductor on an as-needed basis to thereby obtain a negative electrode mixture. Thereafter, the negative electrode mixture is put into a solvent such as an organic solvent to thereby prepare a paste negative electrode mixture slurry. Thereafter, the negative electrode mixture slurry is applied on the opposite sides of the negative electrode current collector 12A to thereby form the negative electrode active material layers 12B. Thereafter, the negative electrode active material layers 12B may be compression-molded. In this manner, the negative electrode active material layers 12B are formed on the respective opposite sides of the negative electrode current collector 12A. Thus, the negative electrode 12 is fabricated.

First, an intermediate mixture slurry is prepared in which the inorganic particles are dispersed and the intermediate binder is dissolved in a solvent such as an organic solvent, following which the intermediate mixture slurry is applied on a surface of the negative electrode 12 (the negative electrode active material layer 12B) to thereby form the intermediate layer 14 serving as a covering layer covering the negative electrode active material layer 12B.

In the case of forming the intermediate layer 14, as described above, the weight ratio RN in the upper layer 14N is set to be greater than the weight ratio RM in the lower layer 14M. Specific examples of methods of forming the intermediate layer 14 include the following two formation methods.

A first formation method uses two paste intermediate mixture slurries, i.e., a first intermediate mixture slurry and a second intermediate mixture slurry that each include the inorganic particles and the intermediate binder and that are different from each other in solids concentration.

In this case, first, the inorganic particles and the intermediate binder are mixed at a mixture ratio corresponding to the weight ratio RM, and the mixture is put into a solvent such as an organic solvent to thereby prepare the first intermediate mixture slurry having a relatively low solids concentration. Thereafter, the inorganic particles and the intermediate binder are mixed at a mixture ratio corresponding to the weight ratio RN, and the mixture is put into a solvent such as an organic solvent to thereby prepare the second intermediate mixture slurry having a relatively high solids concentration. Thereafter, the first intermediate mixture slurry is applied on the surface of the negative electrode 12 (the negative electrode active material layer 12B) to thereby form the lower layer 14M. Lastly, the second intermediate mixture slurry is applied on the surface of the lower layer 14M to thereby form the upper layer 14N.

The lower layer 14M and the upper layer 14N are thereby stacked in this order on the surface of the negative electrode 12. In this manner, the intermediate layer 14 is formed. As is apparent from the formation procedure described above, the lower layer 14M and the upper layer 14N formed here are physically separated from each other. Thus, the intermediate layer 14 is formed into a two-layered structure including the lower layer 14M and the upper layer 14N. As long as the weight ratio RN in the upper layer 14N is greater than the weight ratio RM in the lower layer 14M, respective thicknesses of the lower layer 14M and the upper layer 14N may be equal to each other or different from each other.

In the case where the intermediate layer 14 is formed using the two intermediate mixture slurries described above, the weight ratio R varies intermittently in the thickness direction of the intermediate layer 14. Specifically, in a direction from the negative electrode 12 (the negative electrode active material layer 12B) toward the separator 13, the weight ratio R increases intermittently to change from the weight ration RM to the weight ratio RN with the line L as the border therebetween.

A second formation method uses a single paste precursor mixture slurry including only the intermediate binder with no inorganic particles.

In this case, first, the intermediate binder is put into a solvent such as an organic solvent to thereby prepare the precursor mixture slurry. Thereafter, the precursor mixture slurry is applied on the surface of the negative electrode 12 by supplying the precursor mixture slurry continuously to the surface of the negative electrode 12 (the negative electrode active material layer 12B) through the use of a coating apparatus with a tank containing the precursor mixture slurry. In this case, while stirring the precursor mixture slurry contained in the tank, the inorganic particles are added, in the course of applying the mixture slurry, to the precursor mixture slurry in the tank in such a manner that the amount of addition gradually increases. The intermediate layer 14 including the intermediate binder and the inorganic particles is thereby formed on the surface of the negative electrode 12. As is apparent from the formation procedure described above, this intermediate layer 14 is not physically separated into two in the course of formation, and is thus formed into a single-layered structure. As long as the weight ratio RN in the upper layer 14N is greater than the weight ratio RM in the lower layer 14M, conditions including the amount of addition of the inorganic particles and the rate of addition thereof may be freely chosen.

In the case where the intermediate layer 14 is formed using the single precursor mixture slurry described above, the weight ratio R varies continuously in the thickness direction of the intermediate layer 14. Specifically, in the direction from the negative electrode 12 toward the separator 13, the weight ratio R increases continuously to change from the weight ratio RM to the weight ratio RN.

The electrolyte salt is put into a solvent such as an organic solvent. The electrolyte salt is thereby dispersed or dissolved in the solvent. In this manner, the electrolytic solution is prepared.

First, by a method such as a welding method, the positive electrode lead 15 is coupled to the positive electrode 11 (the positive electrode current collector 11A) and the negative electrode lead 16 is coupled to the negative electrode 12 (the negative electrode current collector 12A). Thereafter, the positive electrode 11 and the negative electrode 12 are stacked on each other with the separator 13 and the intermediate layer 14 interposed therebetween, following which the stack of the positive electrode 11, the negative electrode 12, the separator 13, and the intermediate layer 14 is wound to thereby fabricate a wound body. Thereafter, the wound body is placed inside the depression 20U and the outer package film 20 is folded, following which outer edges of two sides of the outer package film 20 (the fusion-bonding layer) are bonded to each other by a method such as a thermal fusion bonding method. The wound body is thereby contained in the pouch-shaped outer package film 20. Lastly, the electrolytic solution is injected into the pouch-shaped outer package film 20, following which the outer edges of the remaining one side of the outer package film 20 (the fusion-bonding layer) are bonded to each other by a method such as a thermal fusion bonding method. In this case, the sealing film 21 is interposed between the outer package film 20 and the positive electrode lead 15, and the sealing film 22 is interposed between the outer package film 20 and the negative electrode lead 16. The wound body is thereby impregnated with the electrolytic solution. Thus, the wound electrode body 10 is fabricated. In this manner, the wound electrode body 10 is sealed in the pouch-shaped outer package film 20. As a result, the secondary battery of the laminated-film type is assembled.

The secondary battery is charged and discharged in a high temperature environment by using, for example, a thermostatic chamber to thereby apply an activation treatment to the secondary battery. The activation treatment causes a solid electrolyte interphase (SEI) film to be formed on the surface of a component such as the negative electrode 12, thereby stabilizing an electrochemical state of the wound electrode body 10. The secondary battery is thus completed.

Conditions including a treatment temperature and the number of times of charging and discharging during the activation treatment may be freely chosen. In particular, the treatment temperature is preferably within a range from 50° C. to 95° C. both inclusive, and more preferably within a range from 70° C. to 85° C. both inclusive, although not particularly limited thereto. The number of times of charging and discharging is at least once and is not particularly limited further.

According to the secondary battery, the intermediate layer 14 including the inorganic particles and the intermediate binder is disposed between the negative electrode 12 (the negative electrode active material layer 12B) and the separator 13. Further, where the intermediate layer 14 is divided equally into the lower layer 14M and the upper layer 14N in the thickness direction, the weight ratio RN in the upper layer 14N is greater than the weight ratio RM in the lower layer 14M.

In this case, an optimized distribution or dispersion state of the inorganic particles is achieved in the intermediate layer 14, and it thus becomes easier to cause the negative electrode 12 to adhere to the separator 13 via the intermediate layer 14. The negative electrode 12 is thereby firmly fixed to the separator 13, and is thus prevented from easily becoming misaligned with respect to the separator 13 even in a case where the secondary battery is subjected to an external load such as vibrations or a drop. This makes it easier to maintain a state in which the positive electrode 11 and the negative electrode 12 are opposed to each other with the separator 13 interposed therebetween, thus improving the wound electrode body 10 in physical stability (robustness). Further, owing to the negative electrode 12 being disposed at a substantially uniform distance from the separator 13, variations in distance between the positive electrode 11 and the negative electrode 12 are suppressed, and also variations in electrical resistance between the positive electrode 11 and the negative electrode 12 are suppressed. This suppresses precipitation of lithium caused by a local overvoltage increase upon charging and discharging, and thus stabilizes the operations, i.e., charging and discharging, of the wound electrode body 10.

Based upon the above, the secondary battery improves in safety while securing electrochemical performance of the secondary battery. Accordingly, it is possible to achieve both ensuring of the electrochemical performance and improvement of the safety.

In particular, the inorganic particles may include, for example, a metal oxide. This further improves the safety of the secondary battery while ensuring the electrochemical performance of the secondary battery. Accordingly, it is possible to achieve higher effects. In this case, the metal oxide may include, for example, aluminum oxide, the metal nitride may include, for example, aluminum nitride, and the metal hydroxide may include, for example, magnesium hydroxide. This improves the safety of the secondary battery even further, making it possible to achieve even higher effects.

Further, the intermediate layer 14 may have a thickness within the range from 0.1 μm to 5 μm both inclusive. This makes it possible to obtain the above-described advantages while securing insertion and extraction of lithium. Accordingly, it is possible to achieve higher effects.

Further, the intermediate layer 14 may be provided on the surface of the negative electrode 12 on the side opposed to the separator 13. This secures adherence of the intermediate layer 14 to the negative electrode 12, making it possible to achieve higher effects. In this case, the coverage of the intermediate layer 14 may be within the range from 20% to 100% both inclusive. This allows for sufficient adhesion of the negative electrode 12 to the separator 13, making it possible to achieve higher effects.

Further, the separator 13 may have an air permeability within the range from 100 sec/cm³ to 1000 sec/cm³ both inclusive. This improves mobility of lithium during insertion and extraction, making it possible to achieve higher effects.

Further, in a case where the positive electrode 11 includes the lithium-cobalt composite oxide having the layered rock-salt crystal structure and where the negative electrode 12 includes graphite, the negative electrode potential Ef may be within the range from 19 mV to 86 mV both inclusive, and the negative electrode potential variation Ev may be 1 mV or greater. In such a case, even if the charge voltage Ec is increased to 4.38 V or higher, the potential E of the positive electrode 11 is prevented from easily reaching the potential constant region P2 associated with the phase transition, or the potential E of the positive electrode 11 is prevented from easily passing through the potential constant region P2 associated with the phase transition, and moreover, precipitation of lithium metal on the negative electrode 12 is suppressed. This sufficiently improves the secondary battery in safety while securing the electrochemical performance of the secondary battery. Accordingly, it is possible to achieve higher effects.

Further, the secondary battery may be a lithium-ion secondary battery. This makes it possible to obtain a sufficient battery capacity stably through the use of insertion and extraction of lithium. Accordingly, it is possible to achieve higher effects.

Other than the above, according to the negative electrode 12, the intermediate layer 14 serving as a covering layer covers the surface of the negative electrode active material layer 12B, and satisfies the condition that the weight ratio RN in the upper layer 14N is greater than the weight ratio RM in the lower layer 14M described above in relation to the configuration of the intermediate layer 14. Accordingly, for the reasons described above, it is possible for a secondary battery including the negative electrode 12 to achieve a superior battery characteristic.

Next, a description is given of modifications of the above-described secondary battery. The configuration of the secondary battery is appropriately modifiable as described below. It should be understood that any two or more of the following series of modifications may be combined.

### [Modification 1]

In FIG. 4, the intermediate layer 14 is provided on the surface of the negative electrode 12. Thus, the intermediate layer 14 is joined to the negative electrode 12, and is therefore provided integrally with the negative electrode 12. Alternatively, the intermediate layer 14 may be provided on a surface of the separator 13, not the negative electrode 12.

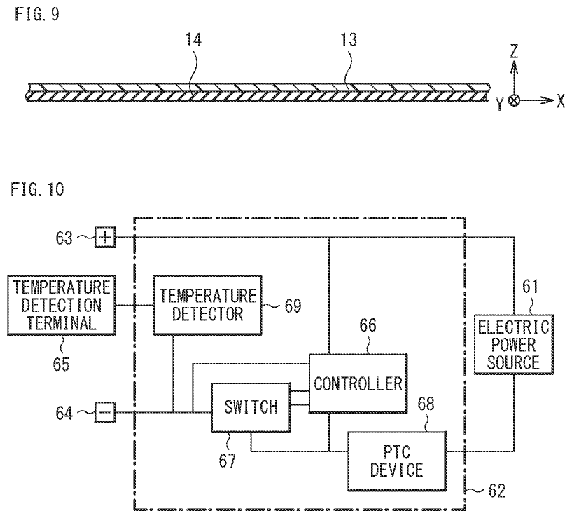

Specifically, as illustrated in FIG. 9 corresponding to FIG. 4, the intermediate layer 14 may be provided on a surface of the separator 13 on a side opposed to the negative electrode 12. FIG. 9 illustrates the separator 13 to be used in the process of manufacturing the secondary battery.

Thus, the intermediate layer 14 is joined to the separator 13, and is therefore provided integrally with the separator 13. The intermediate layer 14 joined to the separator 13 has a configuration similar to that of the intermediate layer 14 joined to the negative electrode 12, except for being joined to the separator 13 instead of being joined to the negative electrode 12. Accordingly, the above-described condition that the weight ratio RN in the upper layer 14N is greater than the weight ratio RM in the lower layer 14M is satisfied also in relation to the intermediate layer 14 joined to the separator 13. In this case, the upper layer 14N and the lower layer 14M are formed in this order on the separator 13.

A procedure to form the intermediate layer 14 joined to the separator 13 is similar to the procedure to form the intermediate layer 14 joined to the negative electrode 12, except that the intermediate layer 14 is formed on the surface of the separator 13, not on the surface of the negative electrode 12. In summary, the intermediate mixture slurry is prepared in which the inorganic particles are dispersed and the intermediate binder is dissolved in a solvent such as an organic solvent, following which the intermediate mixture slurry is applied on the surface of the separator 13 to thereby form the intermediate layer 14. In this case, as described above, the first formation method may be used, or the second formation method may be used.

In a case of using the first formation method, the second intermediate mixture slurry and the first intermediate mixture slurry are applied in this order on the surface of the separator 13 to thereby stack the upper layer 14N and the lower layer 14M in this order on the surface of the separator 13. In a case of using the second formation method, the inorganic particles are added, in the course of applying the precursor mixture slurry, to the precursor mixture slurry in the tank in such a manner that the amount of addition gradually decreases. The upper layer 14N and the lower layer 14M are thereby stacked in this order on the surface of the separator 13.

In this case also, the intermediate layer 14 is interposed between the negative electrode 12 and the separator 13 in the completed secondary battery. Accordingly, it is possible to achieve similar effects.

### [Modification 2]

In FIG. 1, the single positive electrode lead 15 is coupled to the wound electrode body 10. However, the positive electrode lead 15 is not limited to one in number, and two or more positive electrode leads 15 may be provided. Increasing the number of the positive electrode leads 15 results in a decrease in electrical resistance of the wound electrode body 10, making it possible to achieve higher effects. The description given here in relation to the positive electrode lead 15 also applies to the negative electrode lead 16. Thus, for a reason similar to that described in relation to the positive electrode lead 15, the negative electrode lead 16 is not limited to one in number, and two or more negative electrode leads 16 may be provided.

### [Modification 3]

In FIG. 2, the separator 13 which is a porous film is used. However, although not specifically illustrated here, a separator of a stacked type including a polymer compound layer may be used instead of the separator 13 which is the porous film.

Specifically, the separator of the stacked type includes a base layer which is the above-described porous film, and a polymer compound layer provided on one of or each of opposite sides of the base layer. A reason for this is that adherence of the separator to each of the positive electrode 11 and the negative electrode 12 improves to suppress the occurrence of misalignment of the wound electrode body 10. This helps to prevent the secondary battery from easily swelling even if, for example, a decomposition reaction of the electrolytic solution occurs. The polymer compound layer includes a polymer compound such as polyvinylidene difluoride. A reason for this is that such a polymer compound has superior physical strength and is electrochemically stable.

It should be understood that the base layer, the polymer compound layer, or both may each include one or more kinds of particles including, for example, inorganic particles and resin particles. A reason for this is that such particles, including inorganic particles, dissipate heat upon heat generation by the secondary battery, thus improving heat resistance and safety of the secondary battery. The inorganic particles are not particularly limited in kind, and examples thereof include aluminum oxide (alumina), aluminum nitride, boehmite, silicon oxide (silica), titanium oxide (titania), magnesium oxide (magnesia), and zirconium oxide (zirconia).

In a case of fabricating the separator of the stacked type, a precursor solution including, without limitation, the polymer compound and an organic solvent, is prepared and thereafter the precursor solution is applied on one of or each of the opposite sides of the base layer.

Similar effects are obtainable also in the case where the separator of the stacked type is used, as lithium is movable between the positive electrode 11 and the negative electrode 12.

### [Modification 4]

The electrolytic solution which is a liquid electrolyte is used in FIG. 1. However, although not specifically illustrated here, an electrolyte layer which is a gel electrolyte may be used instead of the electrolytic solution.

In the wound electrode body 10 including the electrolyte layer, the positive electrode 11 and the negative electrode 12 are stacked on each other with the separator 13, the intermediate layer 14, and the electrolyte layer interposed therebetween, and the stack of the positive electrode 11, the negative electrode 12, the separator 13, the intermediate layer 14, and the electrolyte layer is wound. The electrolyte layer is interposed between the positive electrode 11 and the separator 13, and between the intermediate layer 14 and the separator 13.

Specifically, the electrolyte layer includes a polymer compound together with the electrolytic solution. The electrolytic solution is held by the polymer compound in the electrolyte layer. The configuration of the electrolytic solution is as described above. The polymer compound includes, for example, polyvinylidene difluoride. In a case of forming the electrolyte layer, a precursor solution including, without limitation, the electrolytic solution, the polymer compound, and an organic solvent, is prepared and thereafter the precursor solution is applied on opposite sides of each of the positive electrode 11 and the negative electrode 12.

Similar effects are obtainable also in the case where the electrolyte layer is used, as lithium is movable between the positive electrode 11 and the negative electrode 12 via the electrolyte layer.

Next, a description is given of applications (application examples) of the above-described secondary battery.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. It should be understood that the secondary battery may have a battery structure of the above-described laminated-film type, a cylindrical type, or any other type. Further, multiple secondary batteries may be used, for example, as a battery pack or a battery module.

In particular, the battery pack and the battery module are each effectively applied to relatively large-sized equipment, etc., including an electric vehicle, an electric power storage system, and an electric power tool. The battery pack, as will be described later, may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

Some application examples of the secondary battery will now be described in detail. The configurations of the application examples described below are merely examples, and are appropriately modifiable.

FIG. 10 illustrates a block configuration of a battery pack including a single battery. The battery pack described here is a simple battery pack (a so-called soft pack) including one secondary battery, and is to be mounted on, for example, electronic equipment typified by a smartphone.

As illustrated in FIG. 10, the battery pack includes an electric power source 61 and a circuit board 62. The circuit board 62 is coupled to the electric power source 61, and includes a positive electrode terminal 63, a negative electrode terminal 64, and a temperature detection terminal (a so-called T terminal) 65.

The electric power source 61 includes one secondary battery. The secondary battery has a positive electrode lead coupled to the positive electrode terminal 63 and a negative electrode lead coupled to the negative electrode terminal 64. The electric power source 61 is couplable to outside via the positive electrode terminal 63 and the negative electrode terminal 64, and is thus chargeable and dischargeable via the positive electrode terminal 63 and the negative electrode terminal 64. The circuit board 62 includes a controller 66, a switch 67, a PTC device 68, and a temperature detector 69. However, the PTC device 68 may be omitted.

The controller 66 includes, for example, a central processing unit (CPU) and a memory, and controls an overall operation of the battery pack. The controller 66 detects and controls a use state of the electric power source 61 on an as-needed basis.

If a battery voltage of the electric power source 61 (the secondary battery) reaches an overcharge detection voltage or an overdischarge detection voltage, the controller 66 turns off the switch 67. This prevents a charging current from flowing into a current path of the electric power source 61. In addition, if a large current flows upon charging or discharging, the controller 66 turns off the switch 67 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 67 includes, for example, a charge control switch, a discharge control switch, a charging diode, and a discharging diode. The switch 67 performs switching between coupling and decoupling between the electric power source 61 and external equipment in accordance with an instruction from the controller 66. The switch 67 includes, for example, a metal-oxide-semiconductor field-effect transistor (MOSFET) including a metal-oxide semiconductor. The charging and discharging currents are detected on the basis of an ON-resistance of the switch 67.

The temperature detector 69 includes a temperature detection device such as a thermistor. The temperature detector 69 measures a temperature of the electric power source 61 using the temperature detection terminal 65, and outputs a result of the temperature measurement to the controller 66. The result of the temperature measurement to be obtained by the temperature detector 69 is used, for example, in a case where the controller 66 performs charge/discharge control upon abnormal heat generation or in a case where the controller 66 performs a correction process upon calculating a remaining capacity.

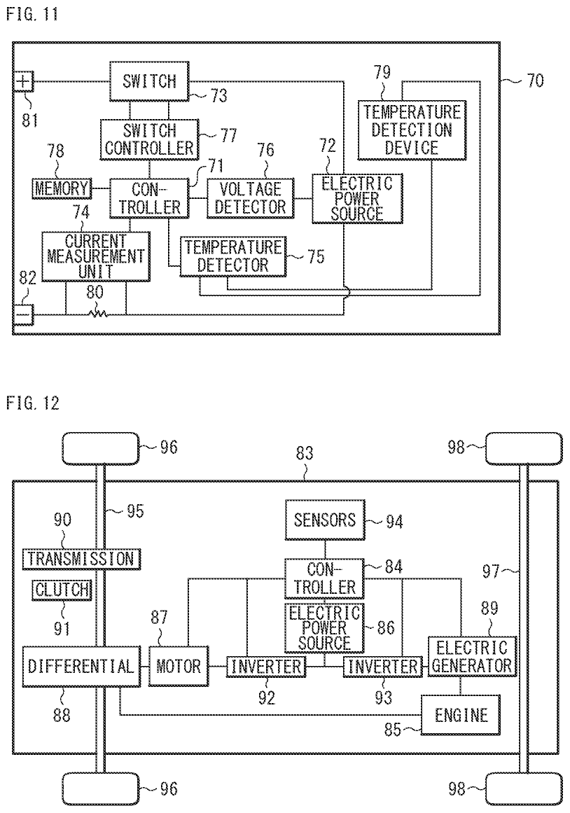

FIG. 11 illustrates a block configuration of a battery pack including an assembled battery. In the following description, reference will be made as necessary to the components of the battery pack including the single battery (FIG. 10).

As illustrated in FIG. 11, the battery pack includes a positive electrode terminal 81 and a negative electrode terminal 82. Specifically, the battery pack includes, inside a housing 70, the following components: a controller 71, an electric power source 72, a switch 73, a current measurement unit 74, a temperature detector 75, a voltage detector 76, a switch controller 77, a memory 78, a temperature detection device 79, and a current detection resistor 80.

The electric power source 72 includes an assembled battery in which two or more secondary batteries are coupled to each other, and a type of the coupling of the two or more secondary batteries is not particularly limited. Accordingly, the coupling scheme may be in series, in parallel, or of a mixed type of both. For example, the electric power source 72 includes six secondary batteries coupled to each other in two parallel and three series.

Configurations of the controller 71, the switch 73, the temperature detector 75, and the temperature detection device 79 are similar to those of the controller 66, the switch 67, and the temperature detector 69 (the temperature detection device). The current measurement unit 74 measures a current using the current detection resistor 80, and outputs a result of the measurement of the current to the controller 71. The voltage detector 76 measures a battery voltage of the electric power source 72 (the secondary battery) and provides the controller 71 with a result of the measurement of the voltage that has been subjected to analog-to-digital conversion.

The switch controller 77 controls an operation of the switch 73 in response to signals supplied by the current measurement unit 74 and the voltage detector 76. If a battery voltage reaches an overcharge detection voltage or an overdischarge detection voltage, the switch controller 77 turns off the switch 73 (the charge control switch). This prevents a charging current from flowing into a current path of the electric power source 72. This enables the electric power source 72 to perform only discharging via the discharging diode, or only charging via the charging diode. In addition, if a large current flows upon charging or discharging, the switch controller 77 blocks the charging current or the discharging current.

The switch controller 77 may be omitted and the controller 71 may thus also serve as the switch controller 77. The overcharge detection voltage and the overdischarge detection voltage are not particularly limited, and are similar to those described above in relation to the battery pack including the single battery.

The memory 78 includes, for example, an electrically erasable programmable read-only memory (EEPROM) which is a non-volatile memory, and the memory 78 stores, for example, a numeric value calculated by the controller 71 and data (e.g., an initial internal resistance, a full charge capacity, and a remaining capacity) of the secondary battery measured in the manufacturing process.

The positive electrode terminal 81 and the negative electrode terminal 82 are terminals coupled to, for example, external equipment that operates using the battery pack, such as a laptop personal computer, or external equipment that is used to charge the battery pack, such as a charger. The electric power source 72 (the secondary battery) is chargeable and dischargeable via the positive electrode terminal 81 and the negative electrode terminal 82.

FIG. 12 illustrates a block configuration of a hybrid automobile which is an example of the electric vehicle. As illustrated in FIG. 12, the electric vehicle includes, inside a housing 83, the following components: a controller 84, an engine 85, an electric power source 86, a motor 87, a differential 88, an electric generator 89, a transmission 90, a clutch 91, inverters 92 and 93, and sensors 94. The electric vehicle also includes a front wheel drive shaft 95, a pair of front wheels 96, a rear wheel drive shaft 97, and a pair of rear wheels 98. The front wheel drive shaft 95 and the pair of front wheels 96 are coupled to the differential 88 and the transmission 90.

The electric vehicle is configured to travel by using one of the engine 85 and the motor 87 as a driving source. The engine 85 is a major power source, such as a gasoline engine. In a case where the engine 85 is used as a power source, a driving force (a rotational force) of the engine 85 is transmitted to the front wheels 96 and the rear wheels 98 via the differential 88, the transmission 90, and the clutch 91, which are driving parts. It should be understood that the rotational force of the engine 85 is transmitted to the electric generator 89, and the electric generator 89 thus generates alternating-current power by utilizing the rotational force. In addition, the alternating-current power is converted into direct-current power via the inverter 93, and the direct-current power is thus accumulated in the electric power source 86. In contrast, in a case where the motor 87 which is a converter is used as a power source, electric power (direct-current power) supplied from the electric power source 86 is converted into alternating-current power via the inverter 92. Thus, the motor 87 is driven by utilizing the alternating-current power. A driving force (a rotational force) converted from the electric power by the motor 87 is transmitted to the front wheels 96 and the rear wheels 98 via the differential 88, the transmission 90, and the clutch 91, which are the driving parts.

When the electric vehicle is decelerated by means of a brake mechanism, a resistance force at the time of the deceleration is transmitted as a rotational force to the motor 87. Thus, the motor 87 may generate alternating-current power by utilizing the rotational force. The alternating-current power is converted into direct-current power via the inverter 92, and direct-current regenerative power is thus accumulated in the electric power source 86.

The controller 84 includes, for example, a CPU, and controls an overall operation of the electric vehicle. The electric power source 86 includes one or more secondary batteries and is coupled to an external electric power source. In this case, the electric power source 86 may be supplied with electric power from the external electric power source and thereby accumulate the electric power. The sensors 94 are used to control the number of revolutions of the engine 85 and to control an angle of a throttle valve (a throttle angle). The sensors 94 include one or more of sensors including, without limitation, a speed sensor, an acceleration sensor, and an engine speed sensor.

The case where the electric vehicle is a hybrid automobile has been described as an example; however, the electric vehicle may be a vehicle that operates using only the electric power source 86 and the motor 87 and not using the engine 85, such as an electric automobile.

Although not specifically illustrated here, other application examples are also conceivable as application examples of the secondary battery.

Specifically, the secondary battery is applicable to an electric power storage system. The electric power storage system includes, inside a building such as a residential house or a commercial building, the following components: a controller, an electric power source including one or more secondary batteries, a smart meter, and a power hub.

The electric power source is coupled to electric equipment such as a refrigerator installed inside the building, and is couplable to an electric vehicle such as a hybrid automobile stopped outside the building. Further, the electric power source is coupled, via the power hub, to a home power generator such as a solar power generator installed at the building, and is also coupled, via the smart meter and the power hub, to a centralized power system of an external power station such as a thermal power station.

Alternatively, the secondary battery is applicable to an electric power tool such as an electric drill or an electric saw. The electric power tool includes, inside a housing to which a movable part such as a drilling part or a saw blade part is attached, the following components: a controller, and an electric power source including one or more secondary batteries.

### EXAMPLES

A description is given of Examples of the technology below.

### Experiment Examples 1-1 to 1-11

Secondary batteries (lithium-ion secondary batteries) of the laminated-film type illustrated in FIGS. 1 to 3 were fabricated, following which the secondary batteries were evaluated for their respective battery characteristics as described below.

The secondary batteries were fabricated in accordance with the following procedure.

First, 91 parts by mass of the positive electrode active material (lithium cobalt oxide (LiCoO₂) as the layered rock-salt lithium-cobalt composite oxide), 3 parts by mass of the positive electrode binder (polyvinylidene difluoride (PVDF)), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on opposite sides of the positive electrode current collector 11A (a band-shaped aluminum foil having a thickness of 12 μm) by means of a coating apparatus, following which the applied positive electrode mixture slurry was dried to thereby form the positive electrode active material layers 11B. Lastly, the positive electrode active material layers 11B were compression-molded by means of a roll pressing machine. In this manner, the positive electrode active material layers 11B were formed on respective opposite sides of the positive electrode current collector 11A. Thus, the positive electrode 11 was fabricated.

First, 93 parts by mass of the negative electrode active material (artificial graphite) and 7 parts by mass of the positive electrode binder (PVDF) were mixed with each other to thereby obtain a negative electrode mixture. Thereafter, the negative electrode mixture was put into an organic solvent (N-methyl-2-pyrrolidone), following the organic solvent was stirred to thereby prepare a paste negative electrode mixture slurry. Thereafter, the negative electrode mixture slurry was applied on opposite sides of the negative electrode current collector 12A (a band-shaped copper foil having a thickness of 15 μm) by means of a coating apparatus, following which the applied negative electrode mixture slurry was dried to thereby form the negative electrode active material layers 12B. Lastly, the negative electrode active material layers 12B were compression-molded by means of a roll pressing machine. In this manner, the negative electrode active material layers 12B were formed on the respective opposite sides of the negative electrode current collector 12A. Thus, the negative electrode 12 was fabricated.

The negative electrode potential Ef (mV) and the negative electrode potential variation Ev (mV) in a case where the charge voltage Ec was set to 4.45 V were as listed in Table 1. Here, the maximum discharge capacity was set to be within a range from 1950 mAh to 2050 mAh both inclusive.

The intermediate layer 14 having the two-layered structure including the lower layer 14M and the upper layer 14N was formed by the foregoing first formation method.

Specifically, first, a mixture of the inorganic particles and the intermediate binder (PVDF) was put into an organic solvent (N-methyl-2-pyrrolidone), following which the organic solvent was stirred. Thus, the inorganic particles were dispersed and the intermediate binder was dissolved in the organic solvent to thereby prepare the first intermediate mixture slurry having a relatively low solids concentration. In this case, the mixture ratio (the weight ratio) between the inorganic particles and the intermediate binder was set to 10:20. Materials of the inorganic particles, that is, materials included in the inorganic particles were magnesium hydroxide (Mg(OH)₂), aluminum oxide (Al₂O₃), silicon oxide (SiO₂), and aluminum nitride (AlN).

Thereafter, the second intermediate mixture slurry having a relatively high solids concentration was prepared by a procedure similar to the above-described procedure by which the first intermediate mixture slurry was prepared, except that the mixture ratio (the weight ratio) between the inorganic particles and the intermediate binder was changed to 10:2.

Thereafter, the first intermediate mixture slurry was applied on a surface of the negative electrode 12 (the negative electrode active material layer 12B) by means of a coating apparatus, following which the first intermediate mixture slurry was dried to thereby form the lower layer 14M.

Lastly, the second intermediate mixture slurry was applied on the surface of the lower layer 14M by means of a coating apparatus, following which the second intermediate mixture slurry was dried to thereby form the upper layer 14N. The lower layer 14M and the upper layer 14N were thereby stacked in this order on the surface of the negative electrode 12. Thus, the intermediate layer 14 having the two-layered structure was formed on the surface of the negative electrode 12 in such a manner that the weight ratio RN in the upper layer 14N was greater than the weight ratio RM in the lower layer 14M.

The thickness (μm) and coverage (%) of the intermediate layer 14 were as listed in Table 1. In the case of forming the intermediate layer 14, the thickness of the lower layer 14M and the thickness of the upper layer 14N were set to be equal to each other.

In the case of forming the intermediate layer 14, the intermediate layer 14 was also formed on a surface of the separator 13 by a similar procedure except that the second intermediate mixture slurry and the first intermediate mixture slurry were applied in this order on the surface of the separator 13 instead of the surface of the negative electrode 12. The location where the intermediate layer 14 was formed, that is, which of the negative electrode 12 and the separator 13 the intermediate layer 14 was formed on, is listed in the “Formation Location” column in Table 1. The formation location of the intermediate layer 14 described here may refer to the location where the intermediate layer 14 was formed in the secondary battery under manufacturing, that is, in the secondary battery before completion, or may be the location where the intermediate layer 14 had been formed in the completed secondary battery, that is, as of a point in time when the secondary battery was disassembled.

For the sake of comparison, no intermediate layer 14 was formed. Further, for the sake of comparison, the intermediate layer 14 was formed on the surface of the negative electrode 12 by a similar procedure except that the order of use of the first intermediate mixture slurry and the second intermediate mixture slurry was reversed. In this case, the intermediate layer 14 having the two-layered structure was formed in which the weight ratio RN in the upper layer 14N was smaller than the weight ratio RM in the lower layer 14M.

The electrolyte salt (lithium hexafluorophosphate (LiPF₆)) was added to a solvent (ethylene carbonate which is a cyclic carbonic acid ester and diethyl carbonate which is a chain carbonic acid ester), following which the solvent was stirred. A mixture ratio (a weight ratio) of the solvent was set as follows: ethylene carbonate/diethyl carbonate=50:50. The content of the electrolyte salt with respect to the solvent was set to 1 mol/kg.

First, the positive electrode lead 15 including aluminum was welded to the positive electrode current collector 11A, and the negative electrode lead 16 including copper was welded to the negative electrode current collector 12A. Thereafter, the positive electrode 11 and the negative electrode 12 were stacked on each other with the separator 13 (a fine-porous polyethylene film having a thickness of 15 μm) and the intermediate layer 14 interposed therebetween, following which the stack of the positive electrode 11, the negative electrode 12, the separator 13, and the intermediate layer 14 was wound to thereby fabricate a wound body.

Thereafter, the outer package film 20 was folded in such a manner as to sandwich the wound body placed in the depression part 20U, following which the outer edges of two sides of the outer package film 20 were thermal fusion bonded to each other to thereby allow the wound body to be contained inside the pouch-shaped outer package film 20. As the outer package film 20, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from the inner side.

Lastly, the electrolytic solution was injected into the pouch-shaped outer package film 20 and thereafter, the outer edges of the remaining one side of the outer package film 20 were thermal fusion bonded to each other in a reduced-pressure environment. In this case, the sealing film 21 (a polypropylene film having a thickness of 5 μm) was interposed between the outer package film 20 and the positive electrode lead 15, and the sealing film 22 (a polypropylene film having a thickness of 5 μm) was interposed between the outer package film 20 and the negative electrode lead 16. The wound body was thereby impregnated with the electrolytic solution. Thus, the wound electrode body 10 was formed. In this manner, the wound electrode body 10 was sealed in the outer package film 20. As a result, the secondary battery of the laminated-film type was assembled.

Lastly, the assembled secondary battery was charged and discharged for one cycle in a thermostatic chamber (at a temperature of 80° C.) to thereby apply an activation treatment to the secondary battery. Upon charging, the secondary battery was charged with a constant current of 0.1 C until a voltage reached 4.43 V, following which the secondary battery was charged with a constant voltage of that value until a current reached 0.05 C. Upon discharging, the secondary battery was discharged with a constant current of 0.1 C until a voltage reached 2.50 V. It should be understood that 0.1 C is a value of a current that causes a battery capacity (a theoretical capacity) to be completely discharged in 10 hours, and 0.05 C is a value of a current that causes the above-described battery capacity to be completely discharged in 20 hours.

The electrochemical state of the wound electrode body 10 was thereby stabilized. Thus, the secondary battery of the laminated-film type was completed.

Evaluation of the secondary batteries for their battery characteristics (a safety characteristic, a cyclability characteristic, and an electrical resistance characteristic) revealed the results presented in Table 1.

In a case of examining the safety characteristic, a collision test was performed on the secondary battery and the state (durability) of the secondary battery after the collision test was visually determined. In the collision test, the secondary battery was placed on the floor, and thereafter a circular-column-shaped weight of SUS having an outer diameter of 15.8 mm and a length of 340 mm was dropped onto the secondary battery. In this case, a drop height of the weight, i.e., a distance between the weight before dropping and the secondary battery, was set to 61 cm.

A case where neither smoking nor ignition occurred as a result of the collision test was determined as “A” indicating that sufficient durability was achieved. A case where smoking occurred but no ignition occurred was determined as “B” indicating that acceptable level of durability was achieved. A case where ignition occurred was determined as “C” indicating that acceptable level of durability was not achieved.

In a case of examining the cyclability characteristic, first, the secondary battery was charged and discharged in an ambient temperature environment (at a temperature of 23° C.) to thereby measure a discharge capacity (a first-cycle discharge capacity). Thereafter, the secondary battery was repeatedly charged and discharged in the same environment until the total number of cycles reached 400 to thereby measure the discharge capacity (a 400th-cycle discharge capacity). Lastly, the following was calculated: capacity retention rate (%)=(400th-cycle discharge capacity/first-cycle discharge capacity)×100. Charging and discharging conditions were similar to the charging and discharging conditions in the activation process described above.

In a case of examining the electrical resistance characteristic, when examining the cyclability characteristic described above, an electrical resistance (a first-cycle electrical resistance) of the secondary battery was measured with a battery tester after the first-cycle charging and discharging, and thereafter an electrical resistance (a 400th-cycle electrical resistance) of the secondary battery was measured with the battery tester after the 400th-cycle charging and discharging. The following was thereby calculated: resistance increase rate (%)=[(400th-cycle electrical resistance−first-cycle electrical resistance)/first-cycle electrical resistance]×100.

TABLE 1
Positive electrode active material: lithium cobalt oxide; Negative electrode active material: artificial graphite

| | | | | | | | Negative electrode | | | | | |
|---|---|---|---|---|---|---|---|---|---|---|---|---|
| | | | | | | | | Negative | Separator | | | |
| | Intermediate layer | | | | | | Negative | electrode | Air | | | |
| | | | Inter- | | Thick- | Cover- | electrode | potential | perme- | | Capacity | Resistance |
| Experiment | Formation | Inorganic | mediate | Distri- | ness | age | potential | variation | ability | | retention | increase |
| example | location | particles | binder | bution | (μm) | (%) | Ef (mV) | Ev (mV) | (sec/cm³) | Durability | rate (%) | rate (%) |
| 1-1 | Negative | Mg(OH)₂ | PVDF | RN > RM | 3 | 50 | 50 | 17 | 300 | A | 93 | 12 |
| 1-2 | electrode | Al₂O₃ | | | | | | | | A | 93 | 11 |
| 1-3 | | SiO₂ | | | | | | | | B | 89 | 15 |
| 1-4 | | AlN | | | | | | | | B | 90 | 17 |
| 1-5 | Separator | Mg(OH)₂ | PVDF | RN > RM | 3 | 50 | 50 | 17 | 300 | A | 88 | 19 |
| 1-6 | | Al₂O₃ | | | | | | | | A | 87 | 18 |
| 1-7 | — | — | — | — | — | — | 50 | 17 | 300 | C | 68 | 45 |
| 1-8 | Negative | Mg(OH)₂ | PVDF | RN < RM | 3 | 50 | 50 | 17 | 300 | A | 71 | 46 |
| 1-9 | electrode | Al₂O₃ | | | | | | | | A | 72 | 49 |
| 1-10 | | SiO₂ | | | | | | | | C | 67 | 52 |
| 1-11 | | AlN | | | | | | | | C | 64 | 44 |

As indicated in Table 1, the durability, the capacity retention rate, and the resistance increase rate each varied greatly depending on the configuration of the secondary battery (the presence or absence of the intermediate layer 14 and the configuration thereof).

Specifically, in a case where the weight ratio RN was greater than the weight ratio RM (Experiment examples 1-1 to 1-6), a satisfactory durability was achieved together with a high capacity retention rate while the resistance increase rate was suppressed to be low, in contrast to a case where no intermediate layer 14 was formed (Experiment example 1-7) and a case where the weight ratio RN was smaller than the weight ratio RM (Experiment examples 1-8 to 1-11). Such a favorable tendency was achieved independently of the formation location of the intermediate layer 14 (i.e., the negative electrode 12 or the separator 13).

In the case where the weight ratio RN was greater than the weight ratio RM, the durability further improved particularly if magnesium hydroxide or aluminum oxide was used as the material of the inorganic particles.

### Experiment Examples 2-1 to 2-5

As described in Table 2, secondary batteries were fabricated and were evaluated for their respective battery characteristics by similar procedures except that the thickness of the intermediate layer 14 was varied. In order to vary the thickness of the intermediate layer 14, respective application amounts of the first intermediate mixture slurry and the second intermediate mixture slurry were adjusted.

TABLE 2
Positive electrode active material: lithium cobalt oxide; Negative electrode active material: artificial graphite

| | | | | | | | Negative electrode | | | | | |
|---|---|---|---|---|---|---|---|---|---|---|---|---|
| | | | | | | | | Negative | Separator | | | |
| | Intermediate layer | | | | | | Negative | electrode | Air | | | |
| | | | Inter- | | Thick- | Cover- | electrode | potential | perme- | | Capacity | Resistance |
| Experiment | Formation | Inorganic | mediate | Distri- | ness | age | potential | variation | ability | | retention | increase |
| example | location | particles | binder | bution | (μm) | (%) | Ef (mV) | Ev (mV) | (sec/cm³) | Durability | rate (%) | rate (%) |
| 2-1 | Negative | Mg(OH)₂ | PVDF | RN > RM | 0.05 | 50 | 50 | 17 | 300 | B | 93 | 12 |
| 2-2 | electrode | | | | 0.1 | | | | | A | 93 | 12 |
| 2-3 | | | | | 1 | | | | | A | 92 | 11 |
| 1-1 | | | | | 3 | | | | | A | 93 | 12 |
| 2-4 | | | | | 5 | | | | | A | 86 | 18 |
| 2-5 | | | | | 10 | | | | | A | 82 | 26 |

As indicated in Table 2, even if the thickness of the intermediate layer 14 was varied, a satisfactory durability was achieved together with a high capacity retention rate while the resistance increase rate was suppressed to be low. In this case, particularly if the thickness of the intermediate layer 14 was within a range from 0.1 μm to 5 μm both inclusive, the durability further improved while the capacity retention rate further increased and the resistance increase rate further decreased.

### Experiment Examples 3-1 to 3-4

As described in Table 3, secondary batteries were fabricated and were evaluated for their respective battery characteristics by similar procedures except that the coverage of the intermediate layer 14 was varied. In order to vary the coverage of the intermediate layer 14, respective solids concentrations of the first intermediate mixture slurry and the second intermediate mixture slurry were adjusted.

TABLE 3
Positive electrode active material: lithium cobalt oxide; Negative electrode active material: artificial graphite

| | | | | | | | Negative electrode | | | | | |
|---|---|---|---|---|---|---|---|---|---|---|---|---|
| | | | | | | | | Negative | Separator | | | |
| | Intermediate layer | | | | | | Negative | electrode | Air | | | |
| | | | Inter- | | Thick- | Cover- | electrode | potential | perme- | | Capacity | Resistance |
| Experiment | Formation | Inorganic | mediate | Distri- | ness | age | potential | variation | ability | | retention | increase |
| example | location | particles | binder | bution | (μm) | (%) | Ef (mV) | Ev (mV) | (sec/cm³) | Durability | rate (%) | rate (%) |
| 3-1 | Negative | Mg(OH)₂ | PVDF | RN > RM | 3 | 10 | 50 | 17 | 300 | B | 91 | 13 |
| 3-2 | electrode | | | | | 20 | | | | A | 92 | 11 |
| 1-1 | | | | | | 50 | | | | A | 93 | 12 |
| 3-3 | | | | | | 80 | | | | A | 90 | 17 |
| 3-4 | | | | | | 100 | | | | A | 88 | 22 |

As indicated in Table 3, even if the coverage of the intermediate layer 14 was varied, a satisfactory durability was achieved together with a high capacity retention rate while the resistance increase rate was suppressed to be low. In this case, particularly if the coverage of the intermediate layer 14 was within a range from 20% to 100% both inclusive, the durability further improved while the high capacity retention rate and the low resistance increase rate were retained.

### Experiment Examples 4-1 to 4-4

As described in Table 4, secondary batteries were fabricated and were evaluated for their respective battery characteristics by similar procedures except that the air permeability of the separator 13 was varied. In order to vary the air permeability of the separator 13, the temperature at the time of the activation treatment was adjusted within a range from 50° C. to 95° C. both inclusive. In this case, the air permeability of the separator 13 exhibited a tendency to increase with increasing temperature at the time of the activation treatment.

TABLE 4
Positive electrode active material: lithium cobalt oxide; Negative electrode active material: artificial graphite

| | | | | | | | Negative electrode | | | | | |
|---|---|---|---|---|---|---|---|---|---|---|---|---|
| | | | | | | | | Negative | Separator | | | |
| | Intermediate layer | | | | | | Negative | electrode | Air | | | |
| | | | Inter- | | Thick- | Cover- | electrode | potential | perme- | | Capacity | Resistance |
| Experiment | Formation | Inorganic | mediate | Distri- | ness | age | potential | variation | ability | | retention | increase |
| example | location | particles | binder | bution | (μm) | (%) | Ef (mV) | Ev (mV) | (sec/cm³) | Durability | rate (%) | rate (%) |
| 4-1 | Negative | Mg(OH)₂ | PVDF | RN > RM | 3 | 50 | 50 | 17 | 50 | B | 92 | 10 |
| 4-2 | electrode | | | | | | | | 100 | A | 92 | 11 |
| 1-1 | | | | | | | | | 300 | A | 93 | 12 |
| 4-3 | | | | | | | | | 1000 | A | 88 | 19 |
| 4-4 | | | | | | | | | 1500 | A | 82 | 26 |

As indicated in Table 4, even if the air permeability of the separator 13 was varied, a satisfactory durability was achieved together with a high capacity retention rate while the resistance increase rate was suppressed to be low. In this case, particularly if the air permeability of the separator 13 was within a range from 100 sec/cm³ to 1000 sec/cm³ both inclusive, the durability further improved while the capacity retention rate further increased and the resistance increase rate further decreased.

### Experiment Examples 5-1 to 5-6

As described in Table 5, secondary batteries were fabricated and were evaluated for their respective battery characteristics by similar procedures except that the negative electrode potential Ef and the negative electrode potential variation Ev were each varied. In order to vary each of the negative electrode potential Ef and the negative electrode potential variation Ev, a mixture ratio (a weight ratio) between the positive electrode active material and the negative electrode active material was adjusted.

TABLE 5
Positive electrode active material: lithium cobalt oxide; Negative electrode active material: artificial graphite

| | | | | | | | Negative electrode | | | | | |
|---|---|---|---|---|---|---|---|---|---|---|---|---|
| | | | | | | | | Negative | Separator | | | |
| | Intermediate layer | | | | | | Negative | electrode | Air | | | |
| | | | Inter- | | Thick- | Cover- | electrode | potential | perme- | | Capacity | Resistance |
| Experiment | Formation | Inorganic | mediate | Distri- | ness | age | potential | variation | ability | | retention | increase |
| example | location | particles | binder | bution | (μm) | (%) | Ef (mV) | Ev (mV) | (sec/cm³) | Durability | rate (%) | rate (%) |
| 5-1 | Negative | Mg(OH)₂ | PVDF | RN > RM | 3 | 50 | 90 | <1 | 300 | A | 77 | 28 |
| 5-2 | electrode | | | | | | 86 | 1 | | A | 89 | 13 |
| 5-3 | | | | | | | 80 | 3 | | A | 90 | 14 |
| 5-4 | | | | | | | 68 | 9 | | A | 91 | 11 |
| 1-1 | | | | | | | 50 | 17 | | A | 93 | 12 |
| 5-5 | | | | | | | 19 | 28 | | A | 90 | 13 |
| 5-6 | | | | | | | 12 | <1 | | A | 78 | 25 |

As indicated in Table 5, even if the negative electrode potential Ef and the negative electrode potential variation Ev were each varied, a satisfactory durability was achieved together with a high capacity retention rate while the resistance increase rate was suppressed to be low. In this case, particularly if the negative electrode potential Ef was within a range from 19 mV to 86 mV both inclusive and the negative electrode potential variation Ev was 1 mV or greater, the capacity retention rate further increased and the resistance increase rate further decreased while the high durability was retained.

Based upon the results presented in Tables 1 to 5, in the case where the intermediate layer 14 (the inorganic particles and the intermediate binder) was interposed between the negative electrode 12 and the separator 13 and where the weight ratio RN in the upper layer 14N was greater than the weight ratio RM in the lower layer 14M in the intermediate layer 14, the safety characteristic improved while the cyclability characteristic and the electrical resistance characteristic were each secured. Accordingly, a superior battery characteristic of the secondary battery was obtained.

Although the technology has been described above with reference to the embodiments and Examples, configurations of the technology are not limited to those described with reference to the embodiments and Examples above and are modifiable in a variety of ways.

Specifically, although the description has been given of the case of using a liquid electrolyte (an electrolytic solution) and the case of using a gel electrolyte (an electrolyte layer), the electrolyte is not particularly limited in kind. Thus, an electrolyte in a solid form (a solid electrolyte) may be used.

Further, although the description has been given of the case where the secondary battery has a battery structure of the laminated-film type, the battery structure is not particularly limited. Accordingly, the battery structure of the secondary battery may be of any other type, such as the cylindrical type, a prismatic type, a coin type, or a button type.

Further, although the description has been given of the case where the battery device has a device structure of the wound type, the device structure of the battery device is not particularly limited. Accordingly, the device structure of the battery device may be of any other type, such as a stacked type in which the positive electrodes and the negative electrodes are alternately stacked, or a zigzag folded type in which the positive electrode and the negative electrode are each folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

It should be understood that the effects described herein are mere examples, and effects of the technology are therefore not limited to those described herein. Accordingly, the present technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode and a negative electrode that are opposed to each other with a separator interposed therebetween; and
an intermediate layer disposed between the negative electrode and the separator and including inorganic particles and a binder,
wherein the intermediate layer includes a first intermediate part that is located closer to the negative electrode in a thickness direction and a second intermediate part that is located farther from the negative electrode in the thickness direction, and wherein a weight ratio of the inorganic particles to the binder in the second intermediate part is greater than that in the first intermediate part.

2. The secondary battery according to claim 1, wherein the inorganic particles include at least one of a metal oxide, a metal nitride, or a metal hydroxide.

3. The secondary battery according to claim 2, wherein
the metal oxide includes at least one of aluminum oxide, silicon oxide, titanium oxide, magnesium oxide, or zirconium oxide,
the metal nitride includes aluminum nitride, and
the metal hydroxide includes magnesium hydroxide.

4. The secondary battery according to claim 1, wherein the intermediate layer has a thickness from 0.1 micrometers to 5 micrometers.

5. The secondary battery according to claim 2, wherein the intermediate layer has a thickness from 0.1 micrometers to 5 micrometers.

6. The secondary battery according to claim 3, wherein the intermediate layer has a thickness from 0.1 micrometers to 5 micrometers.

7. The secondary battery according to claim 1, wherein the intermediate layer is provided on a surface of the negative electrode on a side opposed to the separator.

8. The secondary battery according to claim 2, wherein the intermediate layer is provided on a surface of the negative electrode on a side opposed to the separator.

9. The secondary battery according to claim 3, wherein the intermediate layer is provided on a surface of the negative electrode on a side opposed to the separator.

10. The secondary battery according to claim 4, wherein the intermediate layer is provided on a surface of the negative electrode on a side opposed to the separator.

11. The secondary battery according to claim 7, wherein a coverage of the intermediate layer is from 20 percent to 100 percent of the surface of the negative electrode.

12. The secondary battery according to claim 1, wherein the intermediate layer is provided on a surface of the separator on a side opposed to the negative electrode.

13. The secondary battery according to claim 1, wherein the separator has an air permeability that is from 100 seconds per cubic centimeter 1 to 1000 seconds per cubic centimeter.

14. The secondary battery according to claim 1, wherein
the positive electrode includes a lithium-cobalt composite oxide represented by Formula (1) below and having a layered rock-salt crystal structure, the negative electrode includes graphite,
an open circuit potential, versus a lithium reference electrode, of the negative electrode measured in a full charge state is from 19 millivolts to 86 millivolts, the full charge state being a state in which the secondary battery is charged with a constant voltage of a closed circuit voltage of higher than or equal to 4.38 volts for 24 hours, and
a potential variation of the negative electrode represented by Formula (2) below is greater than or equal to 1 millivolt in a case where the secondary battery is discharged from the full charge state by a capacity corresponding to 1 percent of a maximum discharge capacity, the maximum discharge capacity being a discharge capacity obtainable in a case where the secondary battery is discharged with a constant current from the full charge state until the closed circuit voltage reaches 3.00 volts, following which the secondary battery is discharged with a constant voltage of the closed circuit voltage of 3.00 volts for 24 hours,
LiₓCo_{1-y}M_{y}O_{2-z}X_{z} (1)
wherein
M represents at least one of titanium (Ti), vanadium (V), chromium (Cr), manganese (Mn), iron (Fe), nickel (Ni), copper (Cu), sodium (Na), magnesium (Mg), aluminum (Al), silicon (Si), tin (Sn), potassium (K), calcium (Ca), zinc (Zn), gallium (Ga), strontium (Sr), yttrium (Y), zirconium (Zr), niobium (Nb), molybdenum (Mo), barium (Ba), lanthanum (La), tungsten (W), or boron (B),
X represents at least one of fluorine (F), chlorine (Cl), bromine (Br), iodine (I), or sulfur (S), and
x, y, and z satisfy 0.8<x<1.2, 0<y≤0.15, and 0≤z<0.05,
potential variation (millivolt(s)) of negative electrode=second negative electrode potential (millivolt(s))−first negative electrode potential (millivolt(s)) (2)
wherein
the first negative electrode potential is the open circuit potential, versus the lithium reference electrode, of the negative electrode measured in the full charge state, and
the second negative electrode potential is the open circuit potential, versus the lithium reference electrode, of the negative electrode measured in a state in which the secondary battery is discharged from the full charge state by the capacity corresponding to 1 percent of the maximum discharge capacity.

16. The secondary battery according to claim 1, wherein the secondary battery includes a lithium-ion secondary battery.

17. A negative electrode for a secondary battery, the negative electrode comprising:
a negative electrode active material layer; and
a covering layer covering a surface of the negative electrode active material layer and including inorganic particles and a binder,
wherein the covering layer includes a first covering part that is located closer to the negative electrode active material layer in a thickness direction and a second covering part that is located farther from the negative electrode active material layer in the thickness direction, and wherein a weight ratio of the inorganic particles to the binder in the second covering part is greater than that in the first covering part.
